(19) United States
(12) Patent Application Publication
(10) Pub. No.: US 2026/0362252 A1
(43) Pub. Date: Nov. 12, 2026

(54) Enhancements for Satellite-Based Communications

(71) Applicant: Oswego Technologies, LLC, Columbus, NJ (US)

(72) Inventors: Robert Olesen, Huntington, NY (US); Narayan Menon, Monroe, NJ (US)

(21) Appl. No.: 19/640,338

(22) Filed: Apr. 6, 2026

Related U.S. Application Data
(60) Provisional application No. 63/796,796, filed on Apr. 29, 2025.
(60) Provisional application No. 63/802,465, filed on May 8, 2025.
(60) Provisional application No. 63/819,827, filed on Jun. 8, 2025.

(51) Int. Cl. H04W 36/00; H04B 7/185

(52) U.S. Cl. CPC H04W 36/00692; H04B 7/18513; H04B 7/18519; H04W 36/0079

(57) ABSTRACT

A method for satellite network mobility performed by a wireless device may comprise communicating data through a wireless network via a first connection to a first satellite and predicting a loss of connection to the first satellite. The wireless device may select a second satellite to move to among candidate satellites on different visible orbital planes, wherein the second satellite employs a primary cell which carries an always on synchronization signal block (AO-SSB) and one or more secondary cells which carry an on-demand synchronization signal block (OD-SSB). The wireless device may request that the network enable establishment of a second connection from the device to the selected second satellite, in a multi-connection configuration including the first connection to the first satellite. The wireless device may establish a second connection to the second satellite simultaneous with the first connection with the first satellite.

### CROSS REFERENCE TO RELATED APPLICATIONS

This application claims priority to U.S. Provisional Application No. 63/796,796 filed Apr. 29, 2025, U.S. Provisional Application No. 63/802,465 filed May 8, 2025 and U.S. Provisional Application No. 63/819,827 filed Jun. 8, 2025, the contents of each of which are incorporated by way of reference herein in their entirety.

### BACKGROUND

US Patent Publication No. 20220312301 titled “Method and system for cellular device-satellite communications” to Corey et al. is reproduced by way of reference in its entirety. Corey describes an access network that includes different functional splitting options that relate to combinations of an access network and core network. Specifically, Corey describes a dual connectivity downlink configuration including both terrestrial and satellite connections/traffic flows may be from MEC network to gNB and to an end device and additionally, from MEC network to ground station and onward to the end device directly or indirectly via satellite.

US Patent Publication No. 20250080282 titled “Method and device for hybrid automatic repeat request in inter-satellite multi-connectivity environment” to Suh et al. describes that a secondary node addition operation may be initiated by a master node (MN) and may be an operation for adding a secondary node (SN).

US Patent Publication No. 20240196297 “Method, user equipment, network node, and core network node for mobility management” to Khirallah et al. describes a Receive UE Context Request message sent by a new NG-RAN node (gNB2) to request an old NG-RAN node (gNB1) to transfer the UE Context to the new NG-RAN.

Devices described herein, including user equipment (UE) devices, satellite devices, ground stations, base stations (e.g. gNBs/aNBs) and the like may be configured to communicate and may comprise a processor, a transceiver and a memory for storing instructions.

### SUMMARY

A method for satellite network mobility performed by a wireless device may comprise communicating data through a wireless network via a first connection to a first satellite and predicting a loss of connection to the first satellite. The wireless device may select a second satellite to move to among candidate satellites on different visible orbital planes, wherein the second satellite employs a primary cell which carries an always on synchronization signal block (AO-SSB) and one or more secondary cells which carry an on-demand synchronization signal block (OD-SSB). The wireless device may request that the network enable establishment of a second connection from the device to the selected second satellite, in a multi-connection configuration including the first connection to the first satellite. The wireless device may establish a second connection to the second satellite simultaneous with the first connection with the first satellite.

### BRIEF DESCRIPTION OF THE FIGURES

FIG. 1 illustrates a transparent NTN architecture;

FIG. 2 illustrates a regenerative NTN architecture;

FIG. 3 illustrates a traditional 5G handover scenario;

FIG. 4 illustrates multi-connection protocol and bearer type options;

FIG. 5 illustrates mobility using multi-connection;

FIG. 6 illustrates initial set up—configuration and data flows;

FIG. 7 illustrates final set up—configuration and data flows;

FIG. 8a illustrates RACH procedure and RO beam association;

FIG. 8b illustrates an initial access timing diagram;

FIG. 9 illustrates SSB periodicity for beam hopping;

FIG. 10 illustrates NTN beam patterns;

FIG. 11 illustrates NTN AO-SSB, and OD-SSB Beam Based Scenario;

FIG. 12 illustrates RACH Occasion (RO) Availability;

FIG. 13 illustrates a Transparent NTN Architecture with TN-NTN Multi-Connection;

FIG. 14 illustrates a Regenerative Architecture with TN-NTN Multi-Connection;

FIG. 15 illustrates a Transparent NTN Architecture with TN-NTN Multi-Connection: Feeder Link Switchover;

FIG. 16 illustrates a Feeder Link Switchover Procedure (Transparent Architecture)—Hard Switch;

FIG. 17 illustrates a gNB Selection Procedure FIG. 18 illustrates a Feeder Link Switchover Procedure (Transparent Architecture)—Soft Switch;

FIG. 19 illustrates Feeder Link Switchover (Transparent Architecture)—with Multi-Connectivity;

FIG. 20 illustrates a Regenerative NTN Architecture with TN-NTN Multi-Connection: Feeder Link Switchover;

FIG. 21 illustrates a Feeder Link Switchover (Regenerative Architecture)—with Multi-Connectivity;

FIG. 22 illustrates Service Link Handover;

FIG. 23 illustrates a Classical 3GPP Handover Process; and

FIG. 24 illustrates an Improved Handover Process for Service Link Handover.

### DETAILED DESCRIPTION

A method for satellite network mobility may comprise communicating data, by a device, through a wireless network via a first connection to a first satellite; the device predicting a future loss of connection to the first satellite; the device selecting a second satellite to move to out of the candidate satellites on the different visible orbital planes; the device requesting the network to enable establishment of a second connection from the device to the selected second satellite, in a multi-connection configuration including the device's first connection to the first satellite; requesting, by the device, to the network indicating the identity of the selected second satellite as the second satellite to connect to, wherein the second satellite alters an SSB periodicity of at least one cell, based on information provided by the device; establishing, by the device, a second connection to the second satellite, simultaneous with the device's first connection with the first satellite; as part of the multi-connection setup, the device's data flows get moved, from the first satellite to the second satellite, or being split across the paths through the two satellites; subsequently, providing an indication, by the device, to the network of imminent loss of the service link to the first satellite; releasing, by the device, a connection to the first satellite and staying on the second satellite. In embodiments, the SCELL selected for reduction of the SSB are selected based on the first satellite and the second satellite, including service link break information.

5G non-terrestrial networks (NTN) is a technology meant to enable user devices, close to or on the earth's surface, to connect to the 5G wireless network via non-terrestrial satellites. The baseline 5G system has been adapted to support a satellite-based air interface. Multiple satellite orbital ranges—such as low-earth orbit (LEO), medium-earth orbit (MEO) and geostationary orbit (GEO)—are meant to be supported.

The support of a satellite-based air interface communications introduces fresh challenges into the 5G architecture—driven primarily by the movement of the satellites and the increased latencies created as a result of having to work through the satellites in orbit. In particular, mobility scenarios (e.g. handover) over NTN are considered herein.

This disclosure analyzes the shortcomings of standard 5G with respect to device handovers for 5G NTNs, and presents embodiments to mitigate the issues.

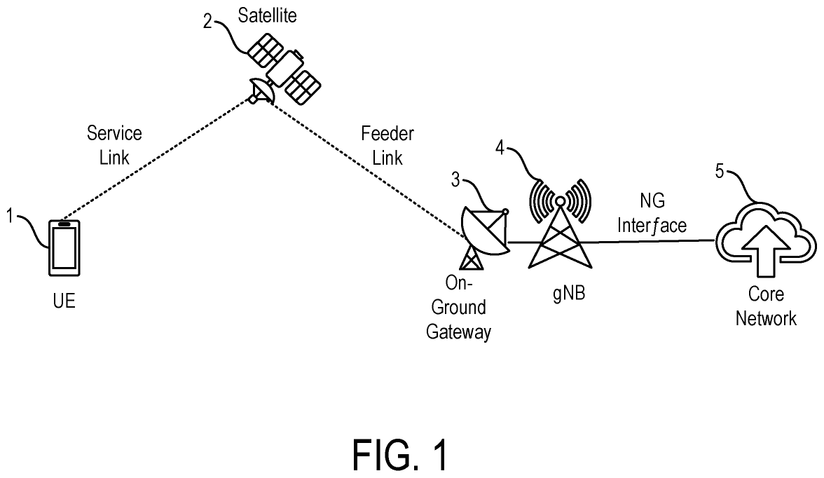

FIG. 1 illustrates the architecture of a transparent 5G NTN system. In the transparent NTN architecture, the classical base station is broken up into a satellite 2 wirelessly coupled to a UE 1, ground gateway 3 and on-ground gNB components 4. The satellite 2 provides RF filtering, frequency conversion, RF amplification and transmission/reception in uplink and downlink directions-corresponding roughly to an analog RF repeater concept. The on-ground gateway 3 receives and transmits signals from/to the satellite 2 over a “feeder link” 6 and passes the signals to/from the on-ground gNB 4. The gNB 4 connects to the 5G Core Network (CN) 5 via the NG interface.

The interface between user device and satellite is referred to as the “service link.”

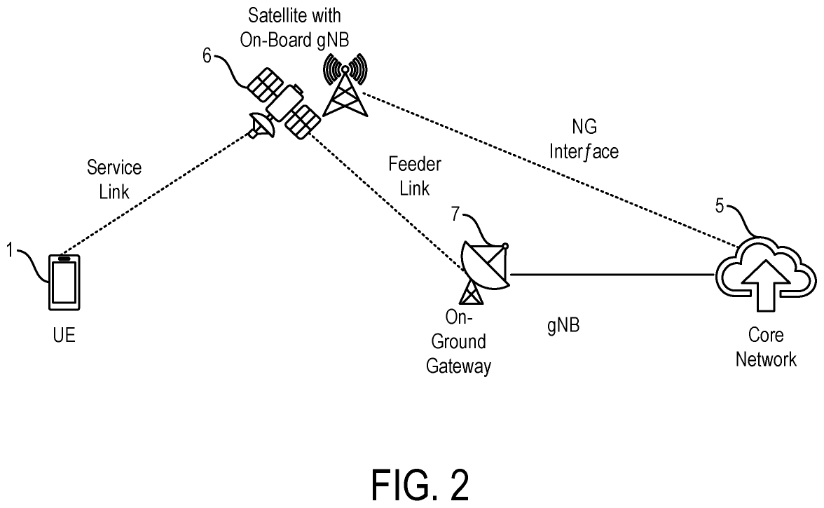

FIG. 2 depicts the architecture of a regenerative 5G NTN system. The major difference from the transparent system is that gNB functions (part or whole) are incorporated into the satellite 6 itself. The satellite 6 can include the entire gNB-Distributed Unit (DU) and Centralized Unit (CU)—and interface via the gateway 7 to the core network 5. Or the satellite may include just the DU component and interface via the F1 interface to the CU on the ground (sitting behind the Gateway). The UE 1 is in communication with satellite 6 via a “service link.”

In addition to the transparent satellite functions, here the satellite supports modulation, demodulation and routing functions, in both uplink and downlink directions.

Handover mobility for baseline 5G systems is well-defined (ref. 3GPP TS 38.300). Handover in 5G is an evolution from earlier 3GPP generations-LTE and earlier generations. Generationally, handover in 3GPP has been network-driven, e.g. handover procedures are triggered, coordinated and executed by the network.

Handover triggering is done by the network, based on radio measurements provided by the device to the network. The handover process proactively reserves resources for the device in the target system (gNB), prior to commanding the device to move to the target system. By the time the device moves to the new (target) gNB, resources would have been reserved for the device on the target system. The process is triggered and executed in real-time, as radio conditions around the device change dynamically.

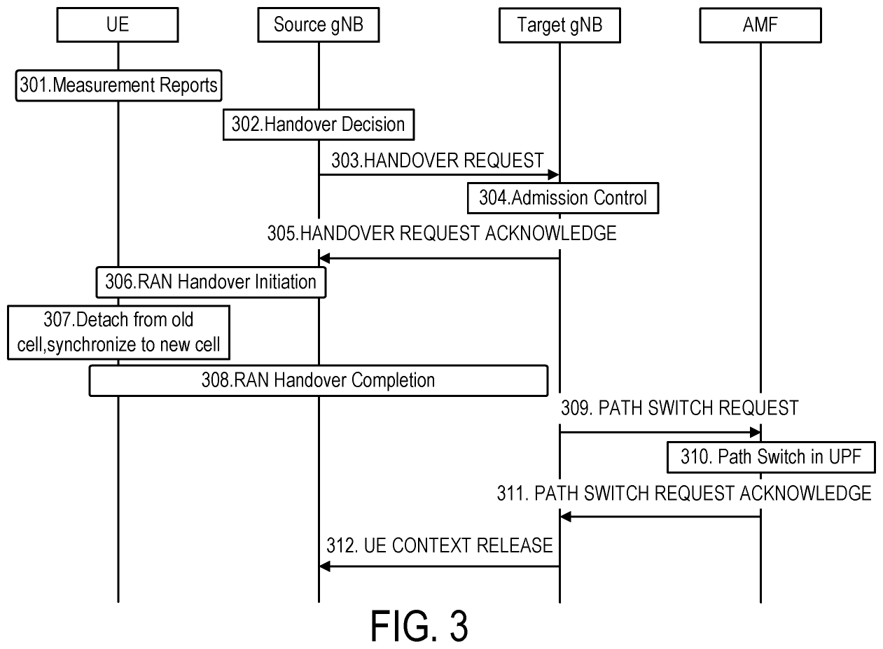

FIG. 3 illustrates the classical 5G handover process for an inter-gNB handover, where a connected-mode device hands-off from a source gNB to a target gNB.

In STEP 301, a device (UE) provides makes measurements of its surrounding radio conditions and provides these measurements to its connected gNB (source gNB) on a continual basis. The measurements include the UE's perceived signal coverage from the source gNB, as well as its received signal strengths from neighboring gNBs. The UE receives a candidate neighbor gNB list (list of neighbor gNBs to monitor) from the gNB via system information broadcast by the gNB. The UE monitors the received signal strengths from these neighbor gNBs and reports the signal strengths to the source gNB. These neighbor gNBs become candidate gNBs for the UE to potentially move to, in a handover situation.

The source gNB processes UE measurements on a continual basis, and inspects the signal strength measurements to see the UE needs to be handed over. Specifically, the gNB sees if the UE's received signal strength from the source gNB drops below minimal (threshold), thereby compromising coverage, and whether a neighbor cell's received signal strength at the UE is higher. If, for example, the UE is at the edge of the cell covered by the source gNB, the UE may see a stronger signal from a neighboring gNB.

In STEP 302, an appropriate point when the source gNB's coverage to the UE has dropped below a certain threshold, and a neighbor gNB's coverage to the UE has been reported to be favorable related to the source gNB, the source gNB may decide to trigger a handover. (Note that the gNB will typically include hysteresis in its handover algorithms to ensure that handover ping-pong effects are avoided). In 3GPP handover scenarios, the target gNB is selected by the network, e.g. by the source gNB.

In STEP 303, the source gNB sends a Handover Request to the selected target gNB. Within the Handover Request, the source gNB includes information on the data flows being supported currently by the UE, and the Quality of Service (QoS) profiles of the data flows.

In STEP 304, the target gNB performs admission control. The purpose of admission control is for the target gNB to determine if it can reserve the required radio resources for the UE, based on the information on the UE's supported data flows and QoS profiles provided in the Handover Request. If the target gNB has the required radio resources, it reserves the radio resources for the incoming UE.

In STEP 305, the target gNB sends a Handover Request Acknowledge to the source gNB, confirming that the target gNB has reserved radio resources for the UE. The Handover Request Acknowledge includes a transparent container to be sent to the UE as an RRC message to perform the handover.

In STEP 306, the source gNB commands the UE to handover by sending an RRC Reconfiguration message to the UE, containing the target cell id and all the information required by the UE to access the target cell on the target gNB.

In STEP 307, the UE detaches from the old cell and synchronizes with the assigned new cell.

In STEP 308, the UE synchronizes to the target cell and completes the RRC handover procedure by sending the RRC Reconfiguration Complete message to target gNB.

In STEP 309, the target gNB sends a Path Switch Request to the Access and Mobility Management Function (AMF) in the 5G Core Network, to trigger the 5G Core to switch the downlink data path towards the target gNB and to establish the NG interface instance towards the target gNB.

In STEP 310, the 5G Core switches the downlink data path towards the target gNB. The User Plane Function (responsible for user plane data handling in the 5G Core) terminates sending data packets on the old path to the source gNB, and releases any user plane tunnel resources towards the source gNB.

In STEP 311, the AMF confirms the Path Switch Request message with the Path Switch Request Acknowledge message.

In STEP 312, the target gNB sends the UE Context Release message to inform the source gNB about the success of the handover. The source gNB then releases radio and control plane resources associated with the UE context. Any ongoing data forwarding may continue.

Changes have been proposed within 3GPP to adapt the baseline 5G architecture to optimally support NTN. This is true for mobility as well, where adaptations have been discussed. However, for handover mobility, shortcomings still exist.

In an NTN system, handover is largely necessitated by satellite movement. LEO and MEO satellites move at fast speeds relative to the earth's rotational speed, and hence each satellite may be visible at a given cell location only for a finite amount of time. In a given LEO/MEO orbital system, in terms of cell coverage, one satellite may give way to the next, and the UEs in the cell may need to switch from one satellite to the next.

As discussed earlier, the 5G handover process is network-driven, and is triggered via radio measurements sent by the UE to the gNB. One issue is the extended latency of communications via a satellite.

The round-trip time (RTT) or long latency is due to the large distance between the UE and the satellite. Each one-way communication involves two satellite transmission legs: the service link between the UE and satellite, and the feeder link between the satellite and ground station (Gateway). “To complicate things further, this RTT depends on the elevation angle and is time-variant. Typical one-way latency values range from 30 ms to 40 ms in LEO and up to 544 ms in GEO constellations.”

In worse-case scenarios, the one-way delay can be orders of magnitude worse than for terrestrial 5G systems. This becomes a critical issue for measurements reporting. Handover decisions rely on highly real-time measurements reporting and processing. Due to large delays in the NTN system, measurement reports can be significantly delayed and can hence be obsolete when received.

Another issue is that the classical measurements-based handover strategy relies on measured relative signal strengths, e.g. between a candidate neighbor base station and the original (source) base station, as seen by the UE. In a terrestrial system, these differences can be definitive enough to provide a sound basis for a handover decision. These effects, e.g. signal attenuation at the UE from the source satellite vs. stronger signal from the target (oncoming) satellite, may not be as significant in an NTN system. Hence, using traditional measurements-based approaches may not suffice in the NTN system.

Issues with Handover Protocol Flow

As discussed earlier, the traditional handover message flow is a lengthy one, with several steps that traverse the satellite with long delays. In a transparent architecture, every interaction between the UE and gNB traverses two ground-satellite hops: the service link and feeder link. In addition, on-ground interactions between the source and target gNBs (over the 5G Xn interface) need to occur.

For a regenerative architecture (where the gNB is on the satellite), feeder link and on-ground traversals need to happen for inter-gNB interactions.

Given that the handover is a very real-time, time-bound process, the delays in these individual steps, added up, may render the whole process ineffective.

### Load on the Network and Scalability

The other issues relate to the load on the network and on scalable handling of handovers by the network. Handover in an NTN system may be driven as much, or more, by the movement of satellites as by movements of the devices themselves. In a LEO or MEO system, as coverage of a cell transitions from one satellite to the next one on the orbital path, it is likely that a large number of UEs may need to be moved from one satellite to the next. The satellite movement may force that to happen.

With a completely network-centric approach, this could place unreasonable loads on the network. Performing the lengthy handover process simultaneously for a large number of devices is likely to be infeasible, especially since the 5G handover process is entirely executed “last-minute”, e.g. at the point where the handover absolutely needs to occur.

Just the measurements handling process—with the network monitoring a large number of devices and processing measurement reports to look for possible handover triggers—can prove overwhelming to the network.

NTN downlink coverage enhancements were considered in 3GPP RAN #106, a revised WID was released, which included the following,

For FR1-NTN and FR2-NTN, dynamic and flexible power sharing between satellite beams and/or different satellite beam parameters has been introduced. Dynamic and/or flexible power sharing between satellite beams may improve power management, particularly for FR2-NTN.

NTN downlink coverage enhancements are described for the following channels: PDCCH at least for CSS Type-1 and/or Type-2 via PDCCH repetition, PDSCH with Msg4 via PDSCH repetition, PDSCH with SIB1 via 2 PDSCH repetitions within 20 ms duration, RACH (Type 1, Type 2), SSB.

In one embodiment multi-connectivity is used to facilitate handover mobility. The UE, anticipating a handover from its currently connected satellite in the near future, proactively sets up a second connection to the next satellite on the orbital path, setting up a multi-connection or carrier aggregation scenario across its current and next satellites, and aggregating bandwidth across the two satellites (and their attendant gNBs).

A neighbor satellite info comes in SIB information. There could be multiple possible neighbors-if multiple orbital streams of satellites are deployed by the operator, e.g. LEO+MEO+GEO. Some options for choosing between these are provided in the detailed message flow section.

Power-related optimizations at PHY and upper layers may be employed in procedures disclosed herein, e.g. optimized power procedures, sleep modes for procedures, etc.

The UE discovers the next satellite via neighbor information (of neighbor satellites and their associated gNBs) broadcasted by the currently connected gNB is system information (SIB information). At the time it needs to handover, the UE moves over to the second satellite by dropping the first-leg connection to the first satellite (and its attendant gNB). This may ensure a seamless intra- and inter-frequency handovers with little to no connection or data loss.

In an embodiment, a multi-connection configuration is set up in advance of the time of handover. Multi-connectivity involves aggregating connections to gNBs, for example, multiple gNBs. This is done so that the operations dealing with multi-connection setup are accomplished ahead of time, and so that the delays associated with satellite communication do not introduce delays into the actual handoff process. This may be done, for example, in cases where the attached gNB changes with the inter-satellite movement. This would be true in the regenerative architecture, with the full gNB on the satellite, since a satellite change here would entail a change in gNB. This could also be true in the transparent architecture, where the source and target satellites are connected on-ground to different gNBs.

In an embodiment, a carrier aggregation configuration is set up in advance of the time of handover. Carrier aggregation involves aggregating connections to multiple cells (carriers) on one gNB. This may be done, for example, so that the operations dealing with carrier aggregation setup are accomplished ahead of time, and so that the delays associated with satellite communication do not introduce delays into the actual handoff process. This is done in cases where the attached gNB remains the same with the inter-satellite movement. This could be true only in the transparent architecture, when the gNB does not change with the inter-satellite movement.

In an embodiment, a UE-triggered initiation of the procedure is performed. The UE, anticipating a handover in the near future, issues a request to the network to set up the multi-connectivity or carrier aggregation configuration. As a result, the network does not need to monitor a large number of devices for handover, or process measurement reports from a large number of UEs. This is an important enhancement to the purely network-driven nature of handover in 3GPP systems, and provides a device-assisted handover approach. This addresses issues with measurement report handling for NTN systems described earlier: the delay issues, scalability/load issues and the problems to do with using signal strength levels in NTNs to detect the need to handover.

In an embodiment, dual-connectivity may be used across a LEO or MEO system to facilitate inter-satellite mobility—to mitigate potential loss of service link (e.g. UE—satellite link). A method for satellite network mobility comprising: a device communicating data through a wireless network via a first connection to a first satellite; the device provides an indication to the network of predicted future loss of the service link to the first satellite; the device receives a trigger from the network to connect to a second satellite; the device establishes a second connection to the second satellite, in dual connectivity with the device's first connection with the first satellite; the device's received signal from the first satellite reduces below a defined threshold, indicating imminent loss of the service link; the device provides an indication to the network of imminent loss of the service link to the first satellite; the device's data flows are moved from the first satellite to the second satellite; the device releases its connection to the first satellite and staying on the second satellite. The satellite network may be a low earth orbit system. The satellite network may be a medium earth orbit system. The prediction of future loss of service link may be derived from prior cyclical knowledge of when the service link breaks have occurred. The prediction of future loss of service link may be derived from analyzing the ephemeris of the satellite chain. The first trigger may be based on a prediction of future loss of service link from the device to the first satellite; The connected network may be a 5G network; The connected network may be a 6G network; The first satellite may be a transparent satellite; The first satellite may be a regenerative satellite; The second satellite may be a transparent satellite; The second satellite may be a regenerative satellite.

In an embodiment, Dual-Connectivity may be used across a LEO/MEO and a GEO (or a Terrestrial Network) to facilitate inter-satellite mobility within a LEO/MEO—to mitigate potential loss of service link (UE—satellite). Device is on a LEO, for example, in preparation to move to another LEO satellite on that network, the device establishes dual-connectivity across the currently connected satellite and another network (e.g. a GEO satellite or a terrestrial network). When the time comes to complete the mobility, the device moves its data flows to the GEO/terrestrial network, moves to the next LEO satellite. Then moves its data flows from the GEO/terrestrial to the new LEO satellite. Thus, it uses the GEO/terrestrial network to “anchor” its data flows. A method for satellite network mobility comprising: a device communicating data via a first connection to a first satellite on a first wireless network; the device providing an indication to the network of predicted future loss of the service link to the first satellite; the device receiving a trigger from the network to establish a second connection to a second network; the device establishing a second connection to the second network, in dual connectivity with the device's first connection with the first satellite on the first network; the device providing an indication to the network of imminent loss of the service link to the first satellite on the first network; the device's data flows getting moved from the first satellite on the first network to the second network; the device releasing its connection to the first satellite on the first network and moving to a second satellite on the first network; the device's flows getting moved from the second network to the second satellite on the first network. The first satellite network is a low earth orbit system. The first satellite network is a medium earth orbit system.

In an embodiment, the trigger is based on a prediction of future loss of service link from the device to the first satellite on the first network. The first network is a 5G network. The first network is a 6G network. The first satellite on the first network is a transparent satellite. The first satellite on the first network is a regenerative satellite. The second satellite on the first network is a transparent satellite. The second satellite on the first network is a regenerative satellite. The second network is a geostationary orbit satellite. The second network is a terrestrial wireless network.

In embodiments, aggregation may be employed across non-terrestrial network and terrestrial network. A method for data aggregation between two networks comprising: a device communicating one or more data flows through a first network; determining the bandwidth and quality of service requirements for each of the data flows supported on the first network; determining that the quality of service requirements for a given data flow on the first network are not being satisfied on the first network; the device making a request to the first network for additional bandwidth; the first network determining free capacity of a second network based on a usage report leveraging the traffic load on the second network; determining, based on the determined free capacity of the second network, that the required quality of service for the given data flow can be satisfied by the second network; a second connection being established for the device with the second network, in dual connectivity with the device's first connection with the first network; moving a percentage of the data flow from the first network to the second network; maintaining the remaining percentage of the data flow on the first network. The first network is a non-terrestrial network. The second network is a terrestrial network. The first network is a terrestrial network. The second network is a non-terrestrial network. The terrestrial network is 4G, 5G or 6G. The non-terrestrial network is 5G or 6G based. The entire data flow is moved to the second network. The data flow is split across the two networks. The decision to move a data flow is driven by throughput requirements for the data flow not currently being satisfied in the first network. The decision to move a data flow is driven by latency requirements for the data flow not currently being satisfied in the first network.

In a multi-connectivity architecture, the Master Node (MN) is the primary node, providing a control plane connection to the Core Network. The Secondary Node (SN) is added on to the Master Node to provide additional resources to the UE. However, the connection to the Core Network is only provided through the MN.

The Master Cell Group (MCG) is a group of serving cells associated with the Master Node, while the Secondary Cell Group (SCG) is a group of serving cells associated with the Secondary Node.

Within the multi-connectivity architecture, three types of bearers are defined. MCG Bearers are supported using only Master Node (MN) radio resources. The MCG Bearer can be MN-terminated or SN-terminated, e.g. the bearer's connection to the Core Network (CN) can be terminated either in the MN or SN.

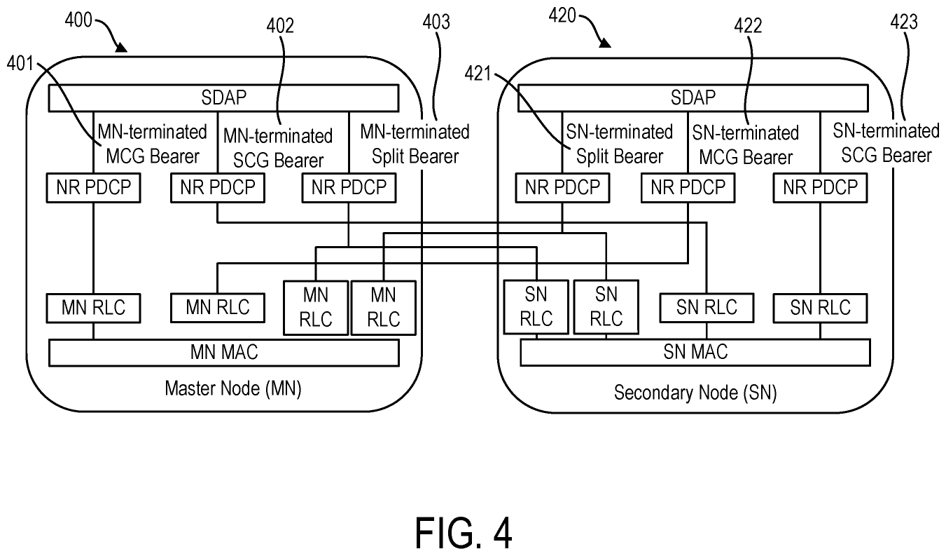

FIG. 4 shows exemplary Master Node (MN) 400 and Secondary Node (SN) 420 configurations with different bearer types depicted. An MN-terminated MCG Bearer 401 terminates its CN connection in the MN 400, and uses radio resources in the MN 400. An SN-terminated MCG Bearer 422 terminates its CN connection in the SN 420, but gets routed to/from the UE via the MN 400 and uses radio resources in the MN 400. An MN-terminated SCG bearer 402 uses radio resources of the SN 420.

Similarly, an SCG Bearer 423 uses only SN 420 radio resources. An SN-terminated SCG Bearer 423 terminates its CN connection in the SN 420, and uses radio resources in the SN 420. An MN-terminated SCG Bearer 402 terminates its CN connection in the MN 400, but gets routed to/from the UE via the SN 420 and uses radio resources in the SN 420.

A Split Bearer is split across Master and Secondary Nodes, and uses radio resources in both MN and SN. A Split Bearer can have its CN connection terminate in either MN or SN. For instance, an SN-terminated split bearer 421 uses radio resources in MN 400 and SN 420. MN-terminated split bearer 403 uses radio resources in MN 400 and SN 420.

The different bearer types and associated RAN protocol configurations are shown in FIG. 4.

In embodiments, multi-connectivity may be used for inter-gNB mobility.

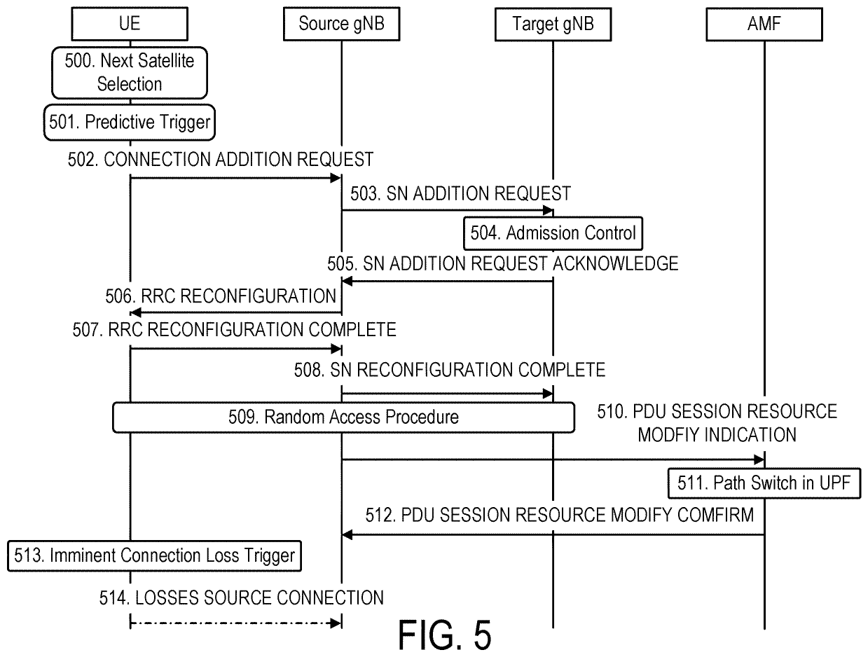

FIG. 5 details the steps undertaken for the UE to move from its currently connected satellite to an oncoming new satellite, with a change of attendant gNB.

In STEP 500, the UE selects a preferred next satellite to connect to. (With LEO and MEO satellite streams, the movement of the satellites relative to the earth's rotation implies that specific satellite come into and leave the UE's coverage zone-implying that the UE is periodically compelled to select a “next” satellite to communicate through).

Satellite selection can also imply a new gNB selection. In the regenerative architecture, where each satellite carries a gNB, a change of satellite implies a change of gNB. A change of gNB is also necessitated in the transparent architecture, where the source and target satellites are supported by different gNBs on the ground.

This process description covers the cases where the gNB changes.

Even in an NTN, the UE may have multiple satellites/gNBs to select from. If the network operator has deployed multiple planes (orbital paths) of satellites, e.g. LEOs, MEOs, GEOs, satellites at multiple orbital planes become viable candidates. The UE can apply multiple criteria for satellite selection:

Use measurements, as in classical 4G or 5G, to determine a node to move to with stronger signal. The issue with this approach is that, depending on the satellites' altitudes and elevation angles, the difference in signal strengths at the UE from the source and target satellites may not be significant enough to select the “better” satellite. Hence, measurements alone may not suffice.

Use past history of satellite changes to determine the best candidate to switch to. The UE can store and use past information on satellite switches made at specific times and UE locations. The satellite ephemeris repeats across rotation cycles, hence this approach is workable.

Use the UE's data flows, and their QoS Flow profiles, to determine which satellite to select. If supporting primarily high-bandwidth flows, choose a GEO satellite to move to. If latency-critical applications are the focus of the device, pick an LEO satellite that may support a lower latency.

In STEP 501, the UE generates a trigger that predicts an upcoming handoff from its currently connected satellite. This trigger is generated in advance of the need for handover becoming critical, e.g. well ahead of actually having to handover. One or a combination of several approaches can be applied to realize a predictive trigger

The UE uses the orbital path information (e.g. the ephemeris) of the serving satellite plane (e.g. LEO or MEO system) to calculate when and where (at what UE location) a loss of connectivity is likely to take place. With the orbital path information for the satellite system well known to the UE (e.g. the network broadcasts the ephemeris etc. to UEs in system information (SIBs)), the UE can use its location and the satellite's ephemeris information to determine a likely break in connectivity in the near future. It makes sense for all of the ephemeris information (for satellites supported by this operator at least) to be broadcasted out on all cells

The UE can predict when/where the next connection break is likely to occur, from past knowledge of when/where the connection has broken (or a handoff occurred) while in the current location. Since the satellite system's orbital flight works repetitively across cycles, this is workable. Additionally, AI can be applied to learn of time-of-day/location patterns of handovers in prior cycles, and of handover outcomes (e.g. post-handover mobility stability, ping-pong effects etc.).

In embodiments, the UE could use its own measurements of coverage from the current satellite to determine the signal is starting to degrade. One difficulty with this approach is that, depending on the satellite's altitude and elevation angle, the signal strength at the UE may not diminish enough to indicate a mobility trigger.

In embodiments, time and location triggers may be alongside measurement reporting, to refine the measurement based approach for NTN systems (as defined in 3GPP Release 17 and 18 specifications).

A combination of the above approaches can be used to determine handover predictively, e.g. use the orbital path approach to make a first prediction, and use past history and/or measurements to confirm.

In any case, the UE applies STEP 501 in advance of the coverage from the source satellite getting lost.

On triggering STEP 501, the UE executes STEP 502. In STEP 502, the UE sends a Connection Addition Request to the source gNB. This may be a new RRC protocol message (or other protocol message), directed from the UE to its connected source gNB. The message requests the source gNB to add, in a multi-connection arrangement, to activate a second connection from the UE to a second gNB/satellite node. This is an important enhancement to the purely network-driven nature of handover in 3GPP systems, and provides a device-assisted handover approach. This step mitigates the need for the network to monitor, and process measurements from, a large number of UEs and determine when to trigger each UE's movement. Given that handover in an NTN is dictated as much by satellite movement as by anything else, it makes sense for the UE to be the master of determining when it needs to make its move, and thereby offload the network of unnecessary workload. Within the Connection Addition Request, the UE suggests a target gNB to additionally connect to in a multi-connection arrangement.

Table 1 shows fields which may be needed within the new RRC message, the Connection Addition Request. In addition to the standard RRC Transaction Identifier, the message includes:
Information on the QoS Flows currently active on the UE and their QoS profiles;
Actions requested for the QoS Flows: whether a flow should be moved over to the new node being added (Secondary Node or target gNB), or whether the flow should be split across source and target gNBs;
Recommended target gNB: target gNB and satellite node selected in STEP 500.

TABLE 1
Connection Addition Request

| Field | Comments |
|---|---|
| RRC Transaction ID | Standard part of RRC message header |
| UE QoS Flow(s) Information | Info on QoS Flows, profiles currently |
| | activated for UE |
| Actions required | For each flow: move flow to Secondary |
| for QoS Flow(s) | Node, or split across Master and |
| | Secondary Nodes |
| Preferred target gNB | gNB selected by UE |

In STEP 503, on receiving the Connection Addition Request, the source gNB (Master Node) sends a SN (Secondary Node) Addition Request to the selected target gNB (SN). Within the SN Addition Request, the source gNB includes information on the data flows to be moved to the SN (target gNB), the Quality of Service (QoS) profiles of the data flows, and the precise bearer types (MN/SN-terminated MCG Bearers, SCG Bearers, Split Bearers) to be established in the multi-connection configuration.

In STEP 504, the target gNB performs admission control, to determine if it can reserve the required radio resources for the UE, based on information on the UE's supported data flows and bearers to be supported by the SN, provided in the SN Addition Request. If the target gNB has the required radio resources, it reserves the radio resources for the incoming UE, as well as required transport network resources to connect to the Core Network.

In STEP 505, the target gNB sends a SN Addition Request Acknowledge to the source gNB, confirming that the target gNB has reserved radio and transport resources for the UE. The SN provides the MN with the new SCG radio resource configuration in a NR RRC configuration message contained in the SN Addition Request Acknowledge message. The MN and SN also exchange transport network information for exchanging inter-gNB information over the Xn interface.

In STEP 506, the source gNB sends to the UE the RRC Connection Reconfiguration message including the NR RRC configuration message, without modifying it, containing the target cell id and all the information required by the UE to access the target cell on the target gNB.

The RRC Connection Reconfiguration message provides the UE all the configuration required for the UE to activate the multi-connection to the Master and Secondary Nodes (source and target gNBs). This includes the precise bearer information (configuration of MCG, SCG and Split Bearers set up on the MN and SN). The mapping of UE QoS Flows to the MCG/SCG/Split Bearers is spelled out. The precise radio bearers mapped to these MCG/SCG/Split Bearers is also provided.

The UE now has all the information to connect to both nodes, and to direct its data flows over the right bearers on the right nodes. If SCG or Split Bearers are configured, the UE should connect to the Secondary Node (target gNB).

In STEP 507, the UE applies the new configuration and replies to the MN with an RRC Connection Reconfiguration Complete message.

In STEP 508, the MN (source gNB) informs the SN (target gNB) that the UE has completed the reconfiguration procedure successfully, via the SN Reconfiguration Complete message.

In STEP 509, If configured with bearers requiring SCG radio resources, the UE performs synchronization towards the target cell of the SN.

In STEP 510, the target gNB sends a Path Switch Request (PDU Session Resource Modify Indication) to the Access and Mobility Management Function (AMF) in the 5G Core Network, to trigger the 5G Core to update the data path towards the gNBs and to establish the NG interface instance towards the target gNB.

In STEP 511, the 5G Core updates the downlink data path towards the gNBs. (If Split Bearers are being set up, the Core Network establishes data paths via both gNBs). The User Plane Function (responsible for user plane data handling in the 5G Core) gets ready to send/receive data along the modified paths to the gNBs.

In STEP 512, the AMF confirms the Path Switch Request message with the PDU Session Resource Modify Confirm message.

Subsequently, when the UE detects an imminent loss of connection to the source satellite (STEP 513), the UE releases the connection to the source satellite/gNB and stays on the target satellite/gNB. Step 514 the UE loses source connection.

### Starting and Ending Configurations

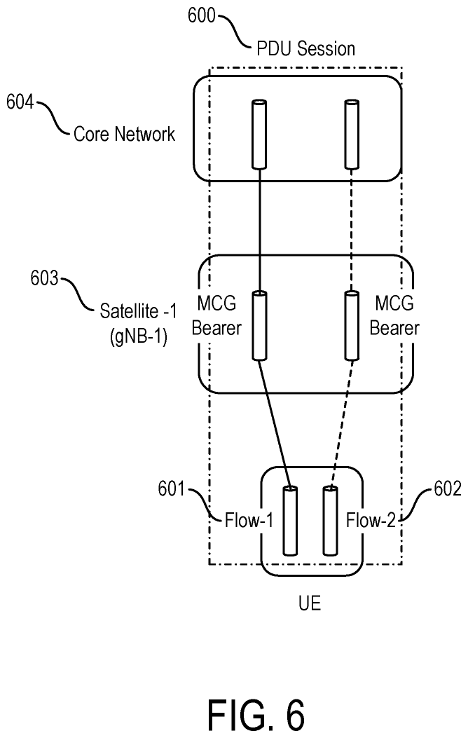

FIG. 6 depicts an example initial protocol/bearer configuration, with just the Master Node (source gNB 603) in operation. The sample configuration shows a PDU Session 600 with two QoS Flows 601, 602. The two flows 601, 602 may traverse only the source gNB 603 in the initial instance. The source gNB 603 supports the control plane connection to the Core Network 604.

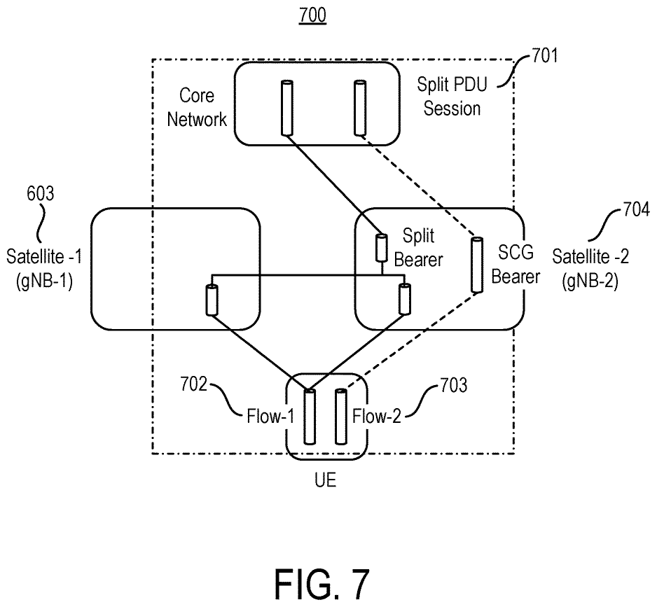

FIG. 7 shows an ending configuration 700, after a multi-connection setup. The source gNB 603 now acts as the Master Node (MN) and a target gNB 704 acts as the Secondary Node (SN). The PDU Session is now split across the MN 603 and SN 704. Specifically, FIG. 7 shows a split PDU session 701, wherein a first flow 702 is split at satellite 2 704 such that flow 1 702 is handled by satellite 1 603 and satellite 2 704. Flow 2 703 is handled by satellite 2.

One of the data flows, flow 2 703, is set up as a SN-terminated SCG Bearer, using radio resources on the SN and terminating its CN connection on the SN. The other QoS Flow, flow 1 702, is set up as a SN-terminated Split Flow, using radio resources on both MN and SN, but connecting to the Core Network from the SN. The control plane connection to the CN may still be supported via the MN.

The method specified here addresses mobility issues, specific to NTN systems, identified earlier.

The UE-assisted (initial trigger comes from the UE) ensures that the network does not need to monitor a large number of devices for handover, or process measurement reports from a large number of UEs. This addresses all the issues with measurement report handling for NTN systems described earlier: the delay issues, scalability/load issues and the problems to do with using signal strength levels in NTNs to detect the need to handover.

The approach of using a multi-connection initially and letting go of the source connection ensures a seamless transition, with little to no connection or data loss.

The idea of setting up the multi-connection or aggregation early, based on an early predictive trigger, ensures that the sequence of operations for setting up the multi-connection/aggregation is undergone early on, and that delays are minimized at the actual time of handover.

NTN Coverage Enhancements are described herein. The capacity of uplink PUSCH is optimized through uplink multiplexing techniques. An internet issue with NTN uplink is that the coverage of the NTN satellites can be very large, and the device density can be very high, especially for IoT NTN, and/or LEO. The large number of simultaneous uplink transmissions imply the need to carefully manage the uplink inter-UE interference. Spectrum availability may initially be limited, again especially for IoT NTN. It is also possible that some groups of UEs may be grouped in dense pockets during some traffic scenarios (e.g. rush hour). Some UEs may be coverage limited, and/or SINR challenged. Flexible techniques for addressing the allocation of resources for these issues are needed.

Initially we assume that GNSS (Global Navigation Satellite System) capabilities are available to the UEs. Therefore, issues with inter-UE timing may be initially set aside for this discussion.

### NTN Orthogonal Cover Code (OCC) for PUCCH

The purpose of Orthogonal Cover Codes (OCC) in 3GPP NTN is to maintain orthogonality between signals from different users, even when those signals experience different channel conditions, inter-UE interference, and/or impairments due to the movement of the satellites and associated devices. 3GPP Release 19 is studying the potential to use uplink Orthogonal Cover Codes (OCC) to facilitate the mitigation of these issues for PUSCH. Note that OCC has already been used for 3GPP NR legacy PDSCH DMRS and PUCCH, and therefore the technique itself is not new.

OCC enables the multiplexing of users where the length is equal to the multiplexing capacity of the OCC. Also, note that NTN uplink may use DFT-s-OFDM for uplink transmissions has a lower PAPR which is advantageous for the UE complexity as well as link margin. Since DFT-s-OFDM is a single carrier waveform it is more challenging to mitigate inter-UE interference, and application of OCC specifically for this case may be advantageous.

3GPP NR supports four PUCCH formats (0, 1, 2, 3, 4) which include short and long PUCCH allocations. PUCCH format 0 supports a short PUCCH format with UE multiplexing up to 12 UEs in the same PRB, and uses sequence selection. PUCCH format 1 supports a long PUCCH format with multiplexing of 36 to 84 UEs. In the same PRB. Additionally, UCI and DMRS may be time multiplexed. PUCCH format 2 supports a short PUCCH format with no multiplexing in the same PRM, e.g. support for one UE. Additionally, UCI and DMRS may be frequency multiplexed. PUCCH format 3 and 4 support a long PUCCH format and support a moderate to large UCI payload. These will not be considered in this embodiment.

Procedures for the 3GPP Release 19 and earlier multiplexing rules for overlapping of PUCCH and PUSCH are defined in section 9 of 38.213. For the purposes of this embodiment, it is considered as a baseline for these procedures.

If a UE is configured with a PUCCH-SCell, the UE shall apply the procedures described in herein for both primary PUCCH group for the Master Cell Group (MSG) and secondary PUCCH group for the Secondary Cell Group (SCG).

PUCCH may be sent with or without repetition. For the case that it is sent without repletion the following may be solutions for a UE procedure for reporting of NTN uplink control information.

PUCCH without repetition may only be scheduled in the first slot of an OCC group. In this case the issue of multiplexing multiple simultaneous PUCCH and PUSCH resources is averted. However, it limits the potential multiplexing gain and associated flexibility.

In an approach the PUCCH without repetition may be sent in the first and second slots of an OCC group. In this case the UCI capacity may be doubled from 2 bits to 4 bits, and the number of multiplexed UEs may increase to 24 UEs.

Legacy rules may be applied to either of these options, for example if two slots are used for PUCCH the legacy rules may be applied to each individually.

Note that whether one or two slots are used, the transmission of PUSCH would be dropped in those slots.

As a reminder in the case that the multiplexing of multiple UEs in a slot it may be possible that a PUCCH without repetition may overlap with PUSCH repetitions on the second or later slot due to legacy rules. This may be addressed by the network, for example the gNB may instruct the UE to suspend PUSCH repetitions in the remaining slots.

For PUCCH with repetition, according to the legacy rules if there is overlap with PUSCH with Type A repetitions, the PUSCH may be dropped in the overlapping slots. For the case that two slots are used for PUCCH with repetition it may be required that PUSCH is always dropped in the second slot.

To address a possible timeline issue the scheduling of PUCCH with repetitions may be required to always start in the first slot of an OCC group.

In the case the PUCCH and/or PUSCH are sent on resources that are on the edge of the BWP resource allocation, the dropping of PUSCH may align with the frequency resource that PUCCH is sent on. Specifically the overlap in frequency of PUCCH and PUSCH may be avoided in the same OCC group.

If PUCCH with repetition and PUSCH with repetition overlap, it may be required that the corresponding PUSCH with repetition is dropped.

If there is more than one OCC group PUSCH may only be dropped in the first OCC group. For subsequent groups PUCCH may only be present in the first slot.

### DEFINITION OF OCC FOR PUCCH AND/OR PUSCH

The OCC may be defined for multiplexing 2, 4, and/or 8 UEs with PUSCH repetitions. w(n) may be used for representing the cover code symbol values as defined in the following equation, w_((n))=e\hat{ }(j2πφ(n)/N_(SF,n)\hat{ }PUSCH).

Where n is the OCC index, SF is the spreading factor, and the Walsh sequence φ-values are precalculated according to tables: Table 2 or Table 3 for multiplexing 2, 4, or 8 UEs respectively.

TABLE 2
OCC Definition for Multiplexing 2 UEs

| OCC Group | | |
|---|---|---|
| index | w_{f}(0) | w_{f}(1) |
| 0 | +1 | +1 |
| 1 | +1 | −1 |

TABLE 3
OCC Definition for Multiplexing 4 UEs

| OCC Group | | | | |
|---|---|---|---|---|
| index | w_{f}(0) | w_{f}(1) | w_{f}(2) | w_{f}(3) |
| 0 | +1 | +1 | +1 | +1 |
| 1 | +1 | −1 | +1 | −1 |
| 2 | +1 | +1 | −1 | −1 |
| 3 | +1 | −1 | −1 | +1 |

The following OCC cover code may be used for 8 TX PUSCH uplink for a maximum rank of 4 or 4 or 8 UEs.

TABLE 4
OCC Definition for Multiplexing 8 UEs

| OCC Group | | | | |
|---|---|---|---|---|
| index | w_{f}(0) | w_{f}(1) | w_{f}(2) | w_{f}(3) |
| 0 | +1 | +1 | +1 | +1 |
| 1 | +1 | −1 | +1 | +1 |
| 2 | +1 | +1 | +1 | +1 |
| 3 | +1 | +1 | +1 | −1 |
| 4 | +1 | −1 | +1 | −1 |
| 5 | +1 | +1 | +1 | −1 |
| 6 | +1 | −1 | +1 | −1 |
| 7 | +1 | −1 | −1 | +1 |

To enable flexibility, it may be desirable to enable flexibility for the use of OCC for PUCCH and/or PUSCH. For example, it may be advantageous to allow an enable/disable capability for the OCC using either a semi-static RRC and/or a dynamic DCI indication. If using a dynamic indication it may be at the slot level and or OCC group level. It may also be on a per BWP basis.

The indication of the OCC index may follow a similar flexibility. It may use either a semi-static RRC and/or a dynamic DCI indication.

The indication of the OCC length and/or sequence may also be either a semi-static RRC indication and or dynamic using a DCI indication.

UCI multiplexing for PUSCH with inter-slot OCC (R1-2502175) is incorporated by reference herein in its entirety.

If PUCCH without repetition overlaps PUSCH with inter-slot OCC with any PUSCH repetitions in an OCC group, that loss of orthogonality may result if the OCC misalignment is not addressed. Note that this issue is the same for either RRC and/or DCI indication of the OCC group however for DCI indication the overhead for addressing the issue may be much higher.

When considering PUSCH with OCC, the multiplexing of UCI presents specific challenges. According to the legacy UCI multiplexing rules outlined in TS 38.213 (for detailed information, see Annex II), if a PUSCH repetition occasion overlaps with a PUCCH carrying UCI, a UE may multiplex the UCI into the overlapped PUSCH repetition, provided certain timeline restrictions between the PUCCH and PUSCH are met.

### PDCCH and SSB Periodicity

Given the extensive coverage of satellites, different traffic loads across multiple beams are prevalent due to societal activity patterns. From a geographical standpoint, higher traffic loads may be anticipated at different times due to rush hour and/or trade patterns. To facilitate flexible associations between the PDCCH(s), SSB(s), and satellite beams during operation, particularly considering varying traffic loads across multiple beams, the appropriate periodicity for each SSB may vary. Additionally, in scenarios where dedicated beams are allocated for connected UEs, the periodicity of SSBs transmitted over these beams may differ from those intended for the initial access stage (e.g., SSBs with the same or different indices). To accommodate these diverse requirements, it appears essential to enhance the system to support varying periodicity per SSB.

System-level enhancements are considered for SS/PBCH blocks that may be used during initial access. This includes support for an extended periodicity of half frames with SS/PBCH blocks during initial access (e.g. for initial access). This includes a maximum additional default incremental value (extended from the existing 20 ms value) of 160 ms. The default values with added extended periodicities may also be assumed by NTN UE for initial access; larger periodicities of 320 ms, and 640 ms may be considered for a particularly large beam footprint, dense network, and/or dense beam pattern. A (e.g. complete) periodicity list may include at least: {40 ms, 80 ms, 160 ms, 320 ms, 640 ms}.

As noted in 3GPP Release 19, based on the results of a DL coverage evaluation at the system level collected from different companies, it has been observed that extending the default value of SSB periodicity in NTN with LEO 600 km satellite parameter sets, where the beam footprint diameter may be 50 km or larger it can be beneficial for reducing the common control channel overhead.

If beam hopping is used, it may worsen the coverage availability, which may also require using periodicities of 320 ms, 640 ms, or even larger periodicities. In this case, indicating the periodicity may require more than a simple presence indication; for example, the beam hopping pattern may be included in the indication.

In 3GPP Release 18, a UE may assume for initial access that half frames (e.g. 10 ms frame) with SS/PBCH blocks occur with a periodicity of 2 frames. When the additional default SSB periodicity (e.g., 160 ms) is used instead of 20 ms, the UE should account for this during the initial cell selection. Since the additional default SSB periodicities are only applicable to NTN, several options may be considered:

160 ms may be considered a default periodicity for a LEO orbit. Note that the orbit, whether LEO, MEO, or GEO, is indicated to the UE in Release 17.

When operating in NTN bands, the UE(s) may assume that the default SSB periodicity is 160 ms.

Each NTN band may be assigned a default SSB periodicity, for example, at least one of: {20 ms, 40 ms, 80 ms, 160 ms, 320 ms, or 640 ms}.

The UE may use blind detection to determine the period that is used.

In case of option (1), if the UE's assumption that the SSB periodicity is 160 ms is incorrect, it may lead to increased overhead and latency in resolving the discrepancy. However, option (2) limits the flexibility available to the network. While blind detection may enhance flexibility, it may also increase overhead.

An embodiment is to tie the available periodicity to the UE type. A low capability UE type may only support a legacy-derived periodicity of 20 ms; in an embodiment, a high capability UE type may use a 160 ms periodicity unless overridden by a 3GPP RAN4 derived table to use 20 ms.

To enable reliable operation, particularly for a beam-hopping situation, all beams within a cell should use the same periodicity. In this case, the most reliable method to convey the desired periodicity for the network is through an SIB1 message. Since the SIB1 message is a cell-level message, it may support reporting more than one periodicity; however, the gNodeB would need to ensure that the appropriate periodicity is used throughout the network.

### PDCCH Repetition

The downlink coverage for PDCCH may be limited in some scenarios.

To improve the PDCCH downlink coverage, inter-slot repetition for the Type 0 PDCCH Common Search Space (CSS) may be considered.

For this, after the acquisition of SIB1 and/or dedicated RRC messages, the indication of the PDCCH repetition parameters is required. Also note that CORESET 0, including the configuration by searchSpaceZero and searchSpaceSIB1, which indicate the physical resources for the PDCCH, and slots for the CORESET 0, are also required.

There are several possible solutions for the indication of the repetition of Type-0 CSS PDCCH configured by searchSpaceZero in MIB: 1) Using the spare 1 bit in MIB, 2) Using reserved bit(s) in PBCH payload, 3) Using codepoint(s) in PBCH payload a) Reserved entries, b) Under the assumption of max. bandwidth, the entries with more than 25 PRBs and/or non-zero RB offset, c) The entries other than those included in solutions 3a and/or 3b, 4) UE blind decoding without signaling from the network during initial access.

Of these, 1 and 3a provide a simple indication of the presence of the PDCCH repetition.

Solutions 2, 3b, and 3c, may provide more information than a simple indication; for example, the positions of the PDCCH repetition. This may be useful for a dense NTN beam based and/or UE deployment.

Solution 4 may allow some flexibility for the network schedule but would incur a higher overhead.

An embodiment may be to indicate the repetition of Type-0 CSS PDCCH configured by searchSpaceZero in MIB using two or three bits in the PBCH payload. As reserved bits are already defined in 3GPP Release 18, one or more of those may be used. It may also be possible to default to blind detection for some scenarios. For example, a low complexity device such as IoT NTN may assume reserved bits are available for an indication of the PDCCH repetition. A higher-capability device, such as an NTN device, may utilize blind detection to supplement information obtained from the reserved bits.

For operations without shared spectrum channel access, and for the SS/PBCH block and CORESET multiplexing pattern 1, a UE monitors PDCCH in the Type 0 PDCCH CSS set over two slots. In an embodiment for SIB1 link level coverage enhancement, the PDSCH repetition of SIB1 may be transmitted within the same slot, or within the same frame modulus, as the type 0 CSS PDCCH repetition. The description of the monitoring frame modulus is derived from the following description: For a SS/PBCH block with index i, the UE determines an index of slot n_0 as,

$${n}_{0} = ( O \cdot {2}^{μ} + ⌊ i \cdot M ⌋ ) mod {N}_{slot}^{frame , μ} \qquad 1 )$$

Where it is an even/odd frame with system frame number (SFN) SFN_{C} satisfying SFN_{c} mod 2=0 if

$$⌊ ( O \cdot {2}^{μ} + ⌊ i \cdot M ⌋ ) / {N}_{slot}^{frame , μ} ⌋ mod 2 = 0 , \qquad 2 )$$

or in a frame with SFN satisfying SFN_{c} mod 2=1 if

$$⌊ ( O \cdot {2}^{μ} + ⌊ i \cdot M ⌋ ) / {N}_{slot}^{frame , μ} ⌋ mod 2 = 1 \qquad 3 )$$

where (mod 2=0) corresponds to even frames, (mod 2=1) corresponds to odd frames, and μ∈{0, 1, 2, 3, 5, 6} is based on the SCS for PDCCH receptions in the monitored CORESET.

In Release 18 it is noted that “For initial cell selection, a UE may assume that half frames with SS/PBCH blocks occur with a periodicity of 2 frames.” In an embodiment for an extended SSB periodicity the UE may assume that half frames with SS/PBCH blocks occur with a periodicity of n frames where n may be dependent on the periodicity: {20 ms, 40 ms, 80 ms, 160 ms, 320 ms, or 640 ms}.

A UE supporting SIB1 PDSCH coverage enhancements may assume that the PDCCH and associated PDSCH are repeated in both slots where the corresponding PDCCHs are transmitted. Each PDSCH SIB1 repetition may be within the same slot of each PDCCH candidate for scheduling the DCI. The repetition may be within a particular Band Width Part (BWP) that is assigned to the NTN band allocation. Also, the two associated PDSCHs should have the same redundancy value (RV). In the case of beam hopping, the PDSCH repetition may be within a particular beam instance.

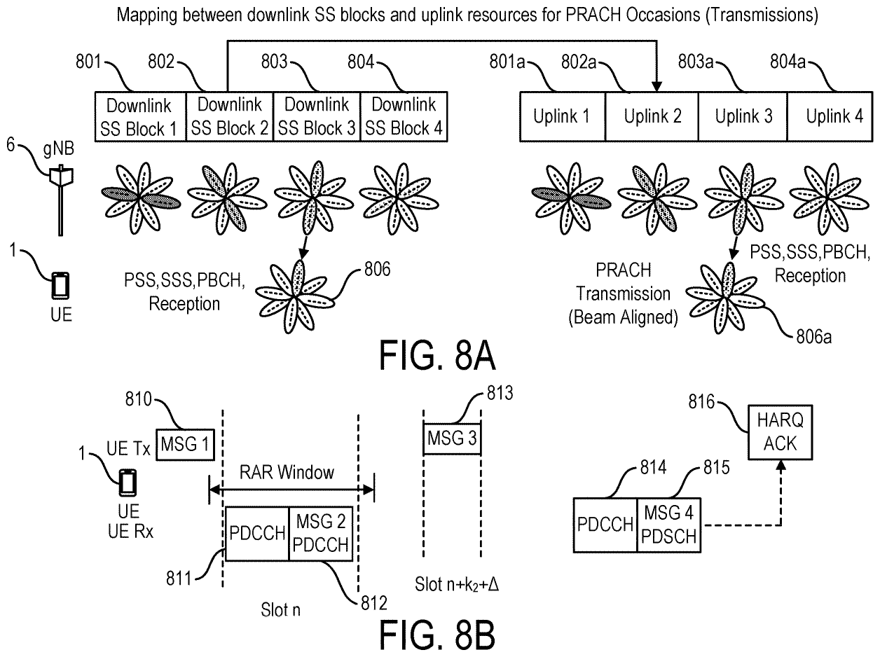

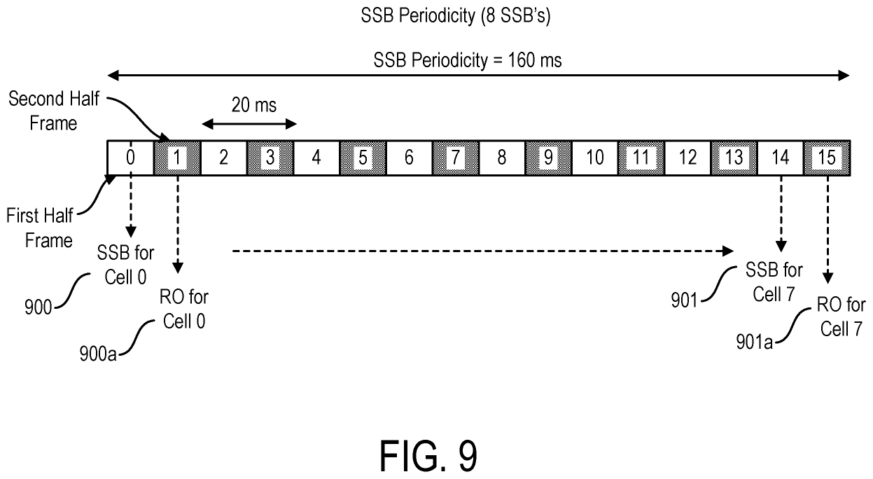

FIG. 8a shows a beam-based RACH procedure with associated RACH Occasions (RO)'s that are aligned with the SSBs that are assigned to beams. It should be noted that an RO may be associated with a particular SSB. After detecting and decoding the SSB, the UE is required to transmit MSG1 using RACH RO resources, wherein the RO resources indicate the transmission opportunities for PRACH. Beam-hopping may be required by the satellite to enable coverage of a very large footprint while maintaining complexity at a tolerable level. During beam-hopping, a beam may be active during the hopping procedure; however, many beams may also be inactive or deactivated.

Specifically, a gNB 6 (ground based or satellite based) may transmit SS blocks 801-804 to a UE 1. SS block 801 may have associated uplink resources 801a dedicated for PRACH occasions. Similarly, SS block 802 may have associated uplink resources 802a dedicated for PRACH occasions. The same may be true with SS block 803 and uplink resources 803a and with SS block 804 and uplink resources 804a. in this example, the UE receives SS block 803 using receive beam 806 and then transmits beam aligned PRACH 806a accordingly.

FIG. 8b shows an initial access timing diagram. The UE may transmit MSG1 810 and then receive PDCCH 811 and MSG2 PDSCH 812 in slot n. At slot n+k_2+Δ, the UE may transmit MSG3 813. The UE transmits a HARQ ACK 816 upon successfully receiving PDCCH 814 and MSG4 PDSCH 815.

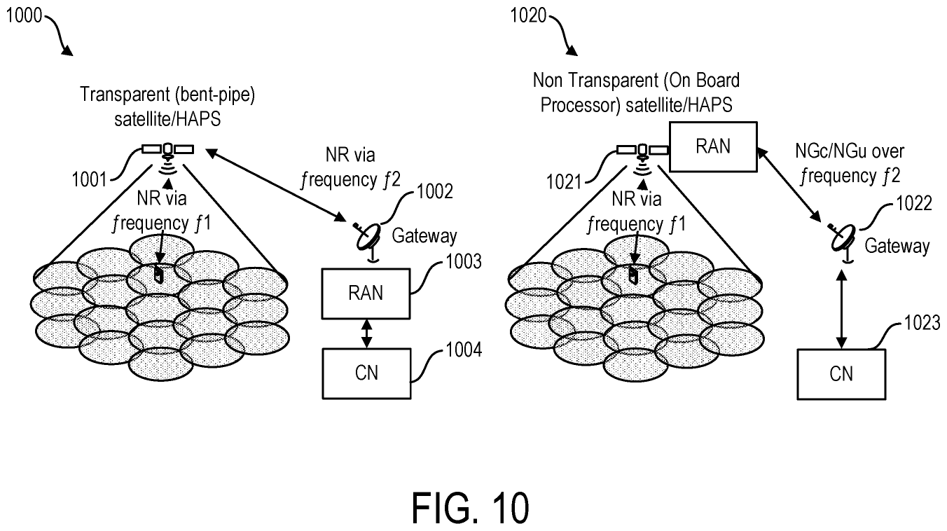

FIG. 9 shows a beam-hopping RACH procedure and associated RO procedure. The legacy based 20 ms periodicity may initially be assumed during initial cell search, however an extended periodicity may be used based on the network scenario, or orbital parameters, as mentioned earlier.

Specifically, FIG. 9 shows that an SSB for cell 0 900 is transmitted in a first half frame and one or more ROs for cell 0 900a are located in the second half frame. This is repeated in accordance with the SSB periodicity with half frame 14 providing SSB for cell 7 and half frame 15 providing RO for cell 7 901a.

Assuming an extended periodicity such as 160 ms is used, it may be used in combination with beam-hopping. A physical beam may transmit SSB bursts to different areas, using different beams, at different time intervals with a 160 ms or similar extended periodicity.

### On-Demand SSB for NTN SCell

A “secondary cell” (SCell) refers to a cell that may be configured as a backup or as an additional connection for an NTN UE. This allows the network to reduce the network overhead by leveraging a secondary connection for the UE(s). Since the UE(s) remains connected to the primary cell (PCell) the necessity for the always on SSB is reduced for the SCell. In an embodiment a solution for an on-demand SSB (OD-SSB) for a NTN SCell is described.

An OD-SSB has been studied for 3GPP Release 19 where the always on SSB (AO-SSB) is maintained for the PCell. There are many scenarios that have been considered for the configuration and timing of an OD-SSB. One of the scenarios considered the triggering/indication timing of the on-demand before and when UE receives an SCell activation command. The previous investigation considered a terrestrial deployment wherein the PCell and SCell exhibit similar propagation delay and timing constraints. However, for an NTN based OD-SSB the propagation delay may be significantly larger (e.g. up to 30 ms for LEO, and up to 400 ms for GEO). In this case the timing considerations for OD-SSB are more critical.

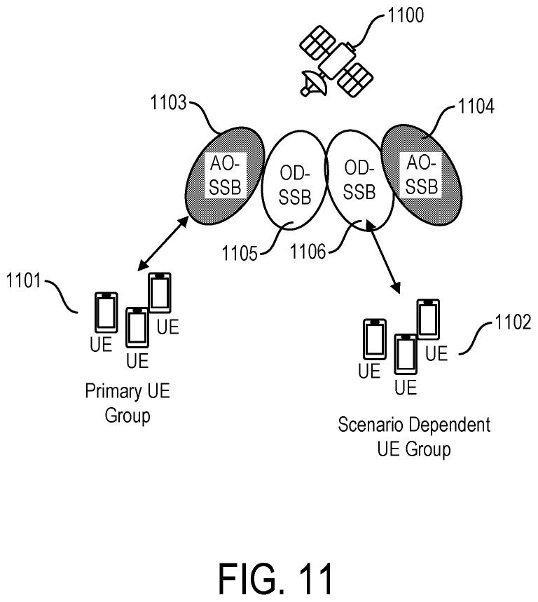

FIG. 10 shows beam-based NTN deployments for a transparent 1000 and regenerative 1020 NTN architecture. As an initial assumption, it may be assumed that the PCell and one or more SCells are defined by a NTN beam-based deployment. Here each, or some, of the beams may be defined by a unique cell ID. For a particular cell, its coverage may be defined by multiple beams, wherein one of the beams is defined as a PCell, and the others are defined as SCells. Each beam may be identified by a Cell ID, and Beam ID, may also be associated with either a PCell or SCell SSB. It may also initially be assumed for this embodiment that the center frequency is within a common band (e.g. S band) for the PCell and SCell. Further it is initially assumed that a Bandwidth Part (BWP) is defined for either the PCell or SCell that it belongs to.

Transparent architecture 1000 includes a transparent satellite/HAPS 1001, gateway 1002, RAN 1003 and CN 1004. Non transparent architecture 1020 includes a non transparent satellite/HAPS 1021, gateway 1022 AND CN 1023.

Although the OD-SSB triggering timing may be up to a network implementation an NTN network should simultaneously consider the timing constraints imposed by a satellite deployment. Some possible solutions include the following. Multi-beam OD-SSB group-common, or UE DCI multi-beam/multi-UE trigger based schedule. An SCell multiple UE defined activation window that may be defined as an SCell group common, and/or multi-UE group trigger based schedule. A multi-UE group defined activation window may be further defined by the availability of KPI measurement information such as RSRP, RSSI, CSI, and/or UE location. Examples of a multi-UE groups may include cell edge, versus cell center UEs. The procedure for SCell activation, versus, SCell OD-SSB trigger, may be different. Specifically, an SCell activation can tolerate a higher latency than a SCell OD-SSB trigger. This may offer an advantage for high mobility UEs since the SCell activation can occur prior to a consideration of a UE's mobility.

In an embodiment an SCell may initially be defined and/or activated without an associated SSB, wherein the network may initially assume that the PCell AO-SSB is sufficient for the scheduling of resources in the SCell. Some SCell UEs and/or multi-UE group(s) may later be scheduled for activation, and triggered, if the UE's condition and/or requirements warrants it.

In an embodiment the half frame index with SS/PBCH blocks should be defined for AO-SSB and OD-SSB in an PCell and/or SCell. Given the latency constraints it should be assumed that the half frame index is the same for both AO-SSB and OD-SSB beams.

For the case where an SCell with an OD-SSB transmission, and a PCell which have different signaling numerology, when UE determines time instance for enabling an OD-SSB, the UE should determine the SCS it should use for the timing configuration. In this case the UE may consider one of the following options. If the PCell and SCell SCS are the same the UE may assume that the SCS is defined by the PCell activation whether it is semi-static via a MAC CE, or dynamic via the active BWP that the SCell belongs. The SCS of the PCell and SCell may be different if either their deployment and/or architecture are different. In this case the UE should determine the correct SCS to use for the OD-SSB timing. In the case of a semi-static indication through a MAC CE, and/or RRC, the UE may assume the SCS that it receives the activation from such as the active BWP with which it belongs. If it receives its activation from a group-common active BWP that is different from the BWP to which it belongs it may assume the SCS it should use is the minimum of the two.

The (NTN) PCell carries a AO-SSB, the (NTN) SCell(s) may carry a OD-SSB. In an embodiment a trigger for a SCell activation may be carried on the PCell which due to timing constraints may have to define a SCell timing activation window which may be similar to a contention-based activation.

The main trigger for OD-SSB may be an SCell activation, in the case of a beam based system it may also be a beam activation as well. Methods for the OD-SSB indication may include RRC or MAC CE based signaling, DCI based, and/or group common DCI based signaling. One question that arises is whether the OD-SSB stays activated once it is triggered, note that this may be independent of the beam activation.

It may also be considered that an OD-SSB based NTN beam may be semi-statically converted to an AO-SSB beam in some situations.

In the interest of minimizing energy, it is desirable to consider DCI based OD-SSB signaling. As a reminder it is assumed that a beam may have the availability of one or more OD-SSB resources to support the potential for different scenarios within a beam and associated BWP. For example, a beam may have one of more BWPs for which each BWP supports a OD-SSB.

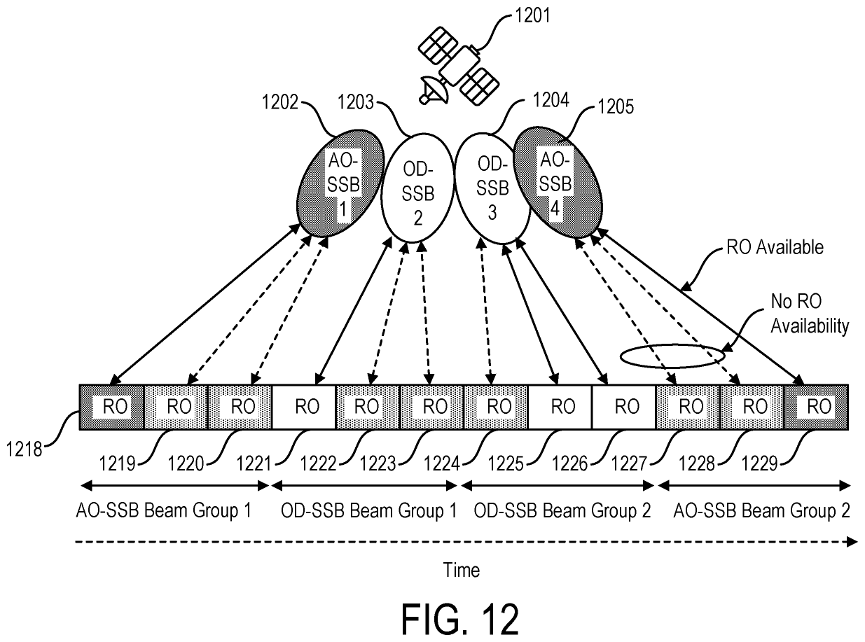

FIG. 11 shows an NTN AO-SSB and OD-SSB beam based scenario of a satellite 1100. In this figure, the OD-SSB based beam 1105, 1106 is shown as a separate UE group 1102, however it may also be an OD-SSB UE group 1102 within the beam footprint of the primary UE group 1101 which receives AO-SSB 1103, 1104.

Support for extended periodicity of the half frames with SS/PBCH blocks may be assumed by UE during initial access. The default value may be 160 ms which is in line with that assumed for the terrestrial requirement. The support for OD-SSB beams may benefit from the support for multiple periodicities. For example, the AO-SSB beam may include information for the periodicities of the OD-SSB beams which may enable a faster cell search for those beams.

The SSB periodicity may also be extended to facilitate beam hopping for common signal/channels such as SSB and SIB1/SIB19. This is because the downlink simultaneous active beams are not as numerous as the thousands of beam footprints of a satellite. Similarly, the UL active beams are likely to be significantly smaller than the number of beam footprints of the satellite. Assuming beam hopping is used, there are two possible configurations: All the beams that participate in a beam hopping scenario use an AO-SSB; an AO-SSB beam may be used to configure additional OD-SSB beams for use in a beam hopping scenario.

In either case, for a given beam footprint, the satellite may not be able to monitor all the configured RACH occasions (RO) between consecutive AO/OD-SSB bursts within that footprint.

Similarly, for an NTN system that may support thousands of beams the complexity for monitoring ROs may be exceedingly high. The use of OD-SSB beams may help to mitigate this issue by enabling the satellite to manage which beam group are either active and/or monitored.

An embodiment is the availability of different RO periodicities for the different beam types (e.g. AO-SSB, OD-SSB, Active/Deactive, Suspended). The prach-ConfigurationIndex may be enhanced to support a range of RO periodicities for each beam and/or SSB type from 20 ms through 160 ms as for example (20 ms, 40 ms, 80 ms, 160 ms). In this case the prach-ConfigurationIndex may be used to configure the AO-SSB beam and/or OD-SSB beam and/or beam group. It is a potential advantage for OD-SSB beams that are initiated from within an AO-SSB beam as it uses a shorter RO periodicity.

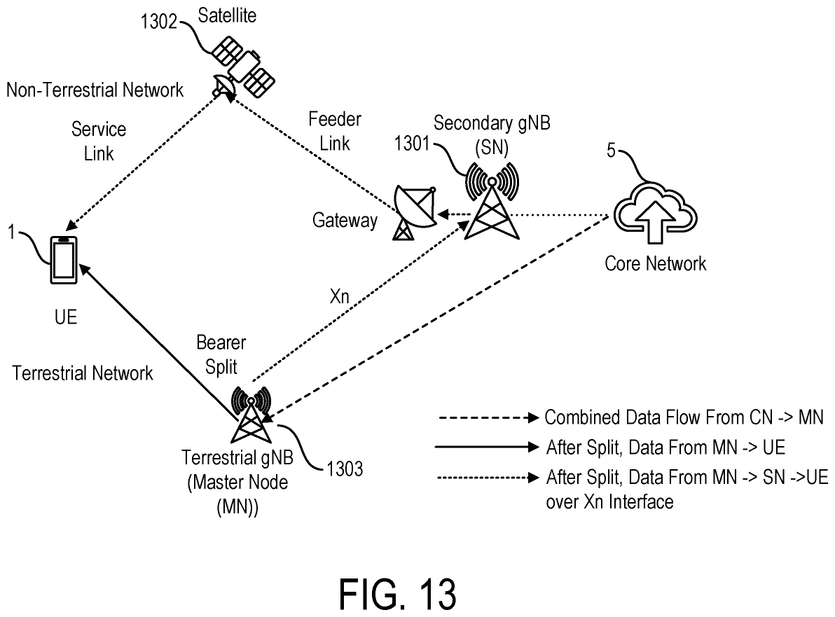

FIG. 12 illustrates a representation of RO opportunities for an NTN system. Since there may be many overlapping occurrences of beam types, the RO periodicities may also be offset from one another. In addition, a starting time may be specified. The starting time and offset may be configured as a part of the prach-ConfigurationIndex.

For example, AO-SSB1 may have associated ROs 1218-1221 for which RO 1219 and RO 1220 are unavailable. OD-SSB2 may have ROs 1221-1223 for which only RO 1221 is available. OD-SSB3 may have ROs 1224-1226 of which RO 1224 is unavailable. AO-SSB4 may have ROs 1227-1229 for which only RO 1229 is available.

SSB periodicity may be reduced in mobility scenarios. By enabling satellite devices to reduce SSB periodicity on cells, overhead is reduced. This enabled UEs to enter sleep mode and conserve energy. In a multiconnection mode, the UE may rely on the secondary node and therefore contention may be reduced and RACH access each time is reduced. Thus, satellites may be able to allocate more resources given the flexible SSB timing, especially given an on demand mechanism.

In embodiments, the SSB periodicity may be adapted based on activities by UEs, for example, UE handover and mobility. In satellite systems, measurements may occur in a clumped fashion due to the mobility of both the UE and the satellite. As a satellite is starting to fade a second (or more) satellite is appearing. The UEs may perform measurements accordingly.

As a new satellite is appearing, in embodiments, the satellite may reduce an SSB rate on the SCELL of the satellite that is appearing. By way of example, a secondary node may be servicing other nodes. For instance, new UEs from a first satellite may be attempting access to the second satellite and during this procedure, e.g. while receiving messages from the UE on the PCELL, the second satellite may reduce periodicity of the SCELL SSB. For example, the only one SCELL of a plurality of SCELLs may need to be made reduced, or all SCELLs may be reduced periodicity.

The first satellite may be a secondary satellite to new UEs the first satellite serves and it may also reduce its SSB timing on the SCELL, as these two satellites are moving closer or further apart.

A satellite may recognize and determine to slow its SSB on the SCELL by reaching a certain time/mode threshold and/or based on UE measurement taking. When the UE sends handover indications (node addition request messages) the satellite may determine to alter, e.g. reduce periodicity of the SCELL SSB. As such, the SCELL addition request messages may trigger the SSB reduction. The network may then reduce a periodicity upon receiving a threshold number of addition requests over a time interval, for a given location, and/or based on a particular satellite.

NTN Intra/Inter-Slot PDCCH Repetition In 3GPP Release 19 PDCCH repetition is supported for PDCCH CSS. There are two possibilities, intra-slot PDCCH repletion and inter-slot PDCCH repetition.

Intra-slot PDDCH repetition for the CSS, other than type 3 CSS, is easily supported for either AO-SSB and/or OD-SSB beams. It may also be observed that intra-slot PDCCH repetition would be preferable for FR2 where the slot length may be much shorter.

For inter-slot PDCCH repetition either intra-beam or inter-beam PDCCH repetition can be supported. In the case that inter-beam PDCCH repetition is supported, it implies that the beams used for inter-beam PDCCH repetition would share the SSB type, either AO-SSB, or if OD-SSB the trigger and activation time of the multiple OD-SSB beams would be the same.

### NTN MSG4 Repetition

It has been agreed that MSG4 repetition should be supported in NTN.

The indication of MSG4 PDSCH repetition may be supported using one or more of the following, Semi-static RRC indication; UE specific repetition indication via DCI; SIB1 configuration; Implicit indication determined by SIB1 PDSCH repetition.

A repetition factor of 2 and/or 4 may be required to address coverage gaps of the satellite. In an embodiment to mitigate excessive signaling would be to specify a repetition factor of 2 using a semi-static RRC indication, if a repetition factor of 4 may be required it may additionally be specified using one of the other options such as a DCI indication. Other combination of signaling the 2 and/or 4 repetition factor are possible.

The MSG4 PDSCH repetition factor may also be dependent on the beam type, for example an AO-SSB beam that has a larger beam footprint may use a larger repetition factor, however a OD-SSB beam than has a smaller footprint may use a legacy repetition factor. The later may also facilitate legacy UEs to connect to the system.

### Enhancements to Enable Multi-Connectivity for NTN

The existing 3GPP 5G standard should be modified to optimally enable Non Terrestrial Network (NTN) operation allied with 5G and 6G systems, and to support multi-connectivity for NTN systems. This document identifies gaps in the current 3GPP standard with respect to NTN systems, and in particular, with TN-NTN and NTN-TN multi-connectivity handling. Embodiments are disclosed herein.

Multi-connectivity may become necessary functionality for NTN systems, both integration of Terrestrial and Non Terrestrial Networks (TN+NTN) in a multi-connectivity configuration. When a UE finds overlapping coverage across a TN and a NTN, the UE may avail of a multi-connected configuration; and integration of two or more NTNs, e.g. a LEO NTN network with a GEO NTN network.

The NTN+TN combination is particularly interesting. The NTN system may be used as a complement to the TN, to provide: extended coverage: to underserved areas, and to enhance coverage for UEs in edge-of-cell conditions; added bandwidth: a single data stream may aggregate bandwidth by adding in the NTN, wherein bandwidth-hungry applications may simultaneously leverage both to access higher bandwidths; offloading: data flows may be offloaded to the NTN to free up the TN, especially during busy hours which is especially true for applications that are not latency-critical, and for best-effort applications for whom QoS requirements are not paramount.

Similar considerations may apply to LEO+GEO integration, for example. Latency-critical applications may be placed on the LEO, while bandwidth-hungry applications may be on the GEO or aggregate bandwidth across the two networks.

### NTN Multi-Connection Architecture—Transparent NTN Architecture

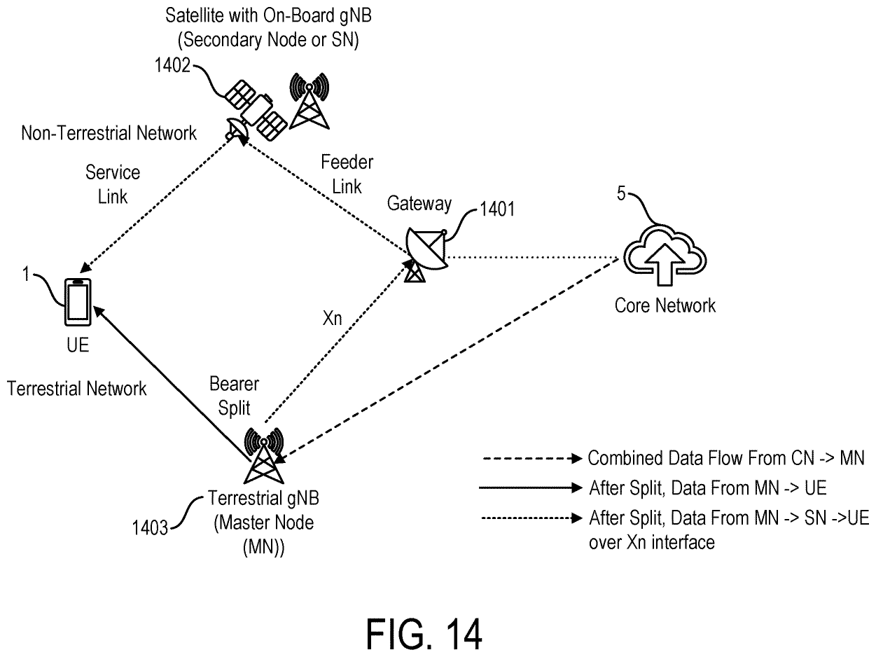

FIG. 13 illustrates the architecture of a transparent NTN system. In the transparent NTN architecture, the classical base station is broken up into a satellite 1302, ground Gateway/on-ground gNB components 1301. The on-ground Gateway receives and transmits signals from/to the satellite 1302 over a “feeder link,” and passes the signals to/from the on-ground gNB. The interface between user device and satellite is referred to as the “service link”. It should be noted that the term gNB, as its used herein, may be interpreted to refer to other network nodes, including network nodes of other generation node Bs or other types of base stations, etc. in no way, is the term gNB as its used herein limited to a 5G or earlier station.

FIG. 13 also depicts a multi-connection architecture integrating the NTN with a Terrestrial Network (TN) 1303. Exemplary data flows show how a data flow (bearer) is split at the Master gNB (TN) and distributed to the UE 1 through the NTN and TN. One part of the split goes from MN (TN gNB) 1303 straight to the UE 1. The other part of the data flow goes from MN to SN over the Xn interface, and gets delivered to the UE 1 by the SN (NTN gNB) via satellite 1302, over the feeder and service links.

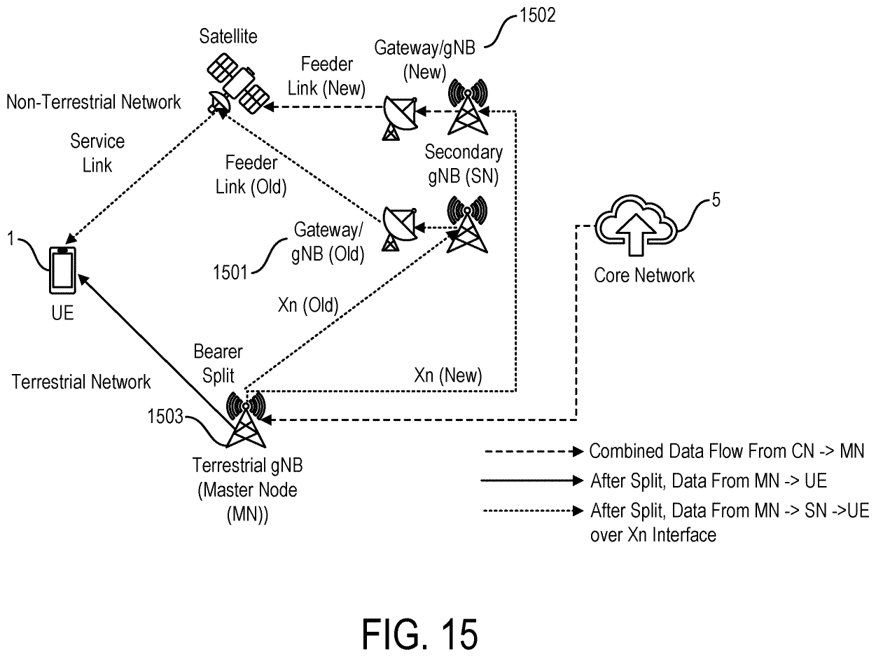

FIG. 14 depicts the architecture of a regenerative NTN system. The major difference from the transparent system is that gNB functions (part or whole) are incorporated into the satellite 1402 itself.

FIG. 14 also depicts a multi-connection architecture integrating the NTN with a Terrestrial Network (TN). Exemplary data flows show how a data flow (bearer) is split at the Master gNB (TN) 1403 and distributed to the UE 1 through the NTN and TN. One part of the split goes from MN (TN gNB) 1403 straight to the UE 1. The other part of the data flow goes from MN to SN over the Xn interface (ground link+feeder link via the on-ground Gateway 1401), and gets delivered to the UE by the SN (NTN gNB) onboard the satellite 1402, over the service link.

### Basic NTN Operation—Feeder Link Switchover

### Feeder Link Switchover (Transparent Architecture)

One with an NTN system is that the feeder link may become unavailable from time to time. This may be due to maintenance, traffic offloading, or (for LEO) due to the satellite moving out of visibility with respect to the current NTN Gateway.

If the feeder link is lost because the satellite goes below the horizon and loses sight of the current Gateway, it needs to connect to a new Gateway (and possibly a new gNB). In this case, all of the connections of all of its UEs need to be reconnected onto the new gNB.

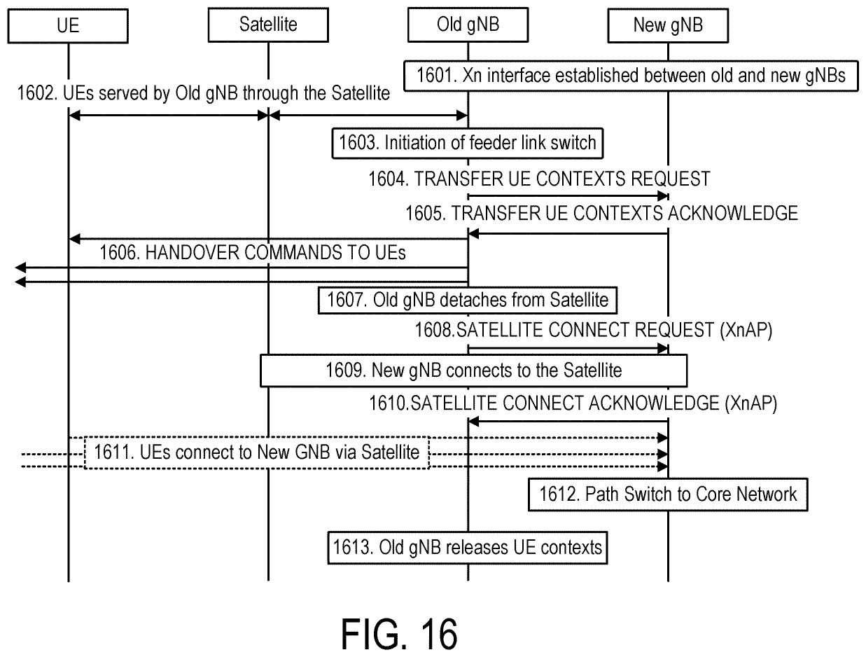

FIG. 15 illustrates a feeder link issue for a transparent NTN system. Here, a feeder link switchover (from old Gateway 1501 to new Gateway 1502) may also result in a gNB change. The satellite moves from old gNB 1501 to new gNB 1502, which means that all UEs connected to the satellite need to be moved from the old gNB 1501 to the new gNB 1502. Using the current standards state-of-the-art, handovers would need to be executed, one for each UE in RRC-CONNECTED state.

The following aspects specific to NTN make this whole process cumbersome, including the fact that a large number of UEs are under a single satellite's footprint. Given the much larger area of coverage of an NTN gNB (compared to a terrestrial gNB), there could be hundreds (potentially thousands) of UEs that need to be handed over to the new gNB as the feeder link switches to the new gNB. Every one of the UEs under the satellite may need to be moved to the new gNB on the new feeder link. The time taken for each handover would typically be longer than for a terrestrial handover. Every signaling step that traverses a satellite link (feeder or service link) takes longer than its counterpart in a terrestrial system.

If the handover is performed the standard 3GPP way, this would result in: Overhead and heavy load for the RAN; A large amount of time taken; significant break in service continuity; inability for several UEs to complete handover by the time the satellite loses sight of the source gNB, resulting in radio link failures for the UEs. These UEs would then have to set up RRC connections all over again.

FIG. 15 demonstrates a multi-connection scenario, showing the NTN multi-connected to a terrestrial 5G system 1503. The pre-existing Xn interface between old gNB (NTN) 1501 and Master (TN) gNB 1503 gets broken when the feeder link switch occurs, and gets reestablished between the new gNB 1502 and Master gNB 1503 at the end of the procedure.

Given the current state-of-the-art, the “other leg” of the multi-connection (the TN leg in this case) does not become aware of the break, or the anticipation of the break, in the NTN link.

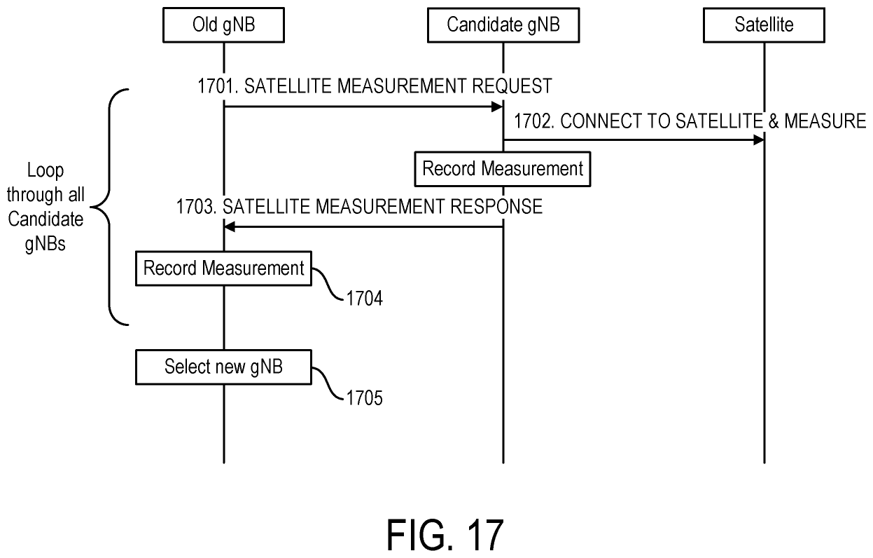

FIG. 16 demonstrates an end-end procedure for feeder link switchover for a transparent architecture. This flow is for a hard switchover, e.g. the satellite is connected to only one Gateway/gNB at a time during the switchover.

Step 1601 To start with, the old (existing) gNB detects that the satellite is moving farther from the gNB, and that a feeder link switchover is imminent. The old gNB has identified a target (new) gNB and Gateway that the satellite should switch the feeder link to, based on the satellite's movement.

Step 1602 UEs are served by the old gNB, via the satellite.

Step 1603 The old gNB makes a decision to switch the satellite to the new Gateway and gNB, sensing that given the satellite's position and movement, a break in the feeder link is imminent.

Step 1604 The old gNB sends a TRANSFER UE CONTEXTS REQUEST message to the new gNB. This transfers the complete contexts of all UEs known by the old gNB (UEs with any context information in the gNB). This includes RRC state information, PDU session and QoS Flow information, radio bearer information and other state and session information maintained at the PDCP and RLC layers. The idea here is to equip the new gNB with all state and session information for all UEs transferring over, so that the sessions, flows and bearers may be continued seamlessly at the new gNB.

Step 1605 The new gNB performs admission control, stores the UEs' context information and returns a TRANSFER UE CONTEXTS ACKNOWLEDGE message to the old gNB. This message indicates the new gNB has reserved resources to admit the UEs, and is willing to support the handover.

Step 1606 The old gNB issues HANDOVER COMMAND messages to all the UEs. (These may be bunched up to avoid creating congestion by sending all of them at once). Each UE is provided a time in the HANDOVER COMMAND at which it is expected to complete the handover, e.g. connect to the new gNB and complete the procedure.

Step 1607 The old gNB detaches from the satellite.

Step 1608 The old gNB sends a SATELLITE CONNECT REQUEST to the new gNB. This may be a new message in the XnAP (Xn control) protocol.

Step 1609 The new gNB connects to the satellite.

Step 1610 The new gNB sends a SATELLITE CONNECT ACKNOWLEDGE message (XnAP) back to the old gNB.

Step 1611 UEs now connect via the satellite to the new gNB.

Step 1612 A path switch is worked out with the Core Network, so that downlink data may now be routed by the CN to the new gNB.

Step 1613 The old gNB releases all UE contexts.

In embodiments, bunching may be performed based on PHY level parameters as disclosed herein. A bunching method may comprise receiving, by at least some UEs, a capability indicator at an old gNB, wherein based on the capability indicator, the UE is grouped (bunched) for handover in accordance with one or more of an always on SSB or an on demand SSB. Bunching method may comprise assigning a group of UEs to a network ID of a plurality of network IDs of a new gNB and handing over the group of UEs to the network ID and handing over another group of UEs to another network ID which is different from the network ID, wherein both the network ID and the another network ID are of the plurality of network IDs. Groups (bunches) may have a same or different orthogonal cover code, wherein the OCC is assigned to the UE, wherein the OCC is associated with a network ID.

Menon et al. describe in US20070291695 that “a PDCP sub-layer performs functions such as header compression. PDCP SDUs (service data units) are input into the PDCP sub-layer, and PDCP PDUs are output and sent to an RLC sub-layer. The PDCP PDUs are viewed as RLC SDUs, from the perspective of the RLC sub-layer. US Patent Pub. No. 20070173283 is also reproduced by reference in its entirety herein and any embodiments described therein may be used in combination with embodiments described herein. In embodiments, a layer split may be performed at the MAC and/or PHY layers. In the case of a MAC split, a cross scheduler may be employed. Decisions to perform a split at the PHY may be based on signaling or other parameters disclosed herein.

Triggers for start of feeder link switch procedure (Step 1603 in FIG. 16):

The feeder link switchover starts when the source (old) gNB determines the need for the switchover. The decision is triggered by one or more of the following conditions:

The old gNB, which monitors constantly the feeder link signal strength received from the currently connected satellite, observes the signal strength dropping below an initial threshold (S1). This tells the old gNB that a feeder link switch may need to happen in the near future. The old gNB selects a new gNB to switch the feeder link to. The old gNB also starts to create “bunches” of UEs that it may group together in its handover request and handover command processes (see sections below for details).

When the feeder link signal strength drops below a second threshold (S2), the old gNB initiates the feeder link switchover process.

S1 and S2 may be also be learned over time using machine learning models. Satellite movement may tend to be cyclical, and may exhibit repetitive patterns in terms of when and where the satellite is when feeder link strength crosses thresholds S1 and S2. The gNB may use this knowledge to predictively determine when to trigger the procedure.

The gNB may use a combination of the predictive and measurement oriented data to determine when to trigger the feeder link switch.

US patenttent Publication no. 20250063408 and US patenttent Publication no. 20240378485 each to Ali Esswie are reproduced herein by reference in their entirety to support the determination of the first and second threshold (s1) and (s2). Any embodiments described therein may be used in combination with embodiments described herein.

Selection of new gNB:
Multiple methods may be leveraged by the old gNB to select a new gNB (and Gateway) to switch the satellite's feeder link to:
Pull together a list of Candidate gNBs to switch the feeder link to. This initial list may be gleaned based on: (a) neighbor gNB information that is configured in the NTN system; (b) knowledge of which gNBs have been used with the satellite in the area on past days.

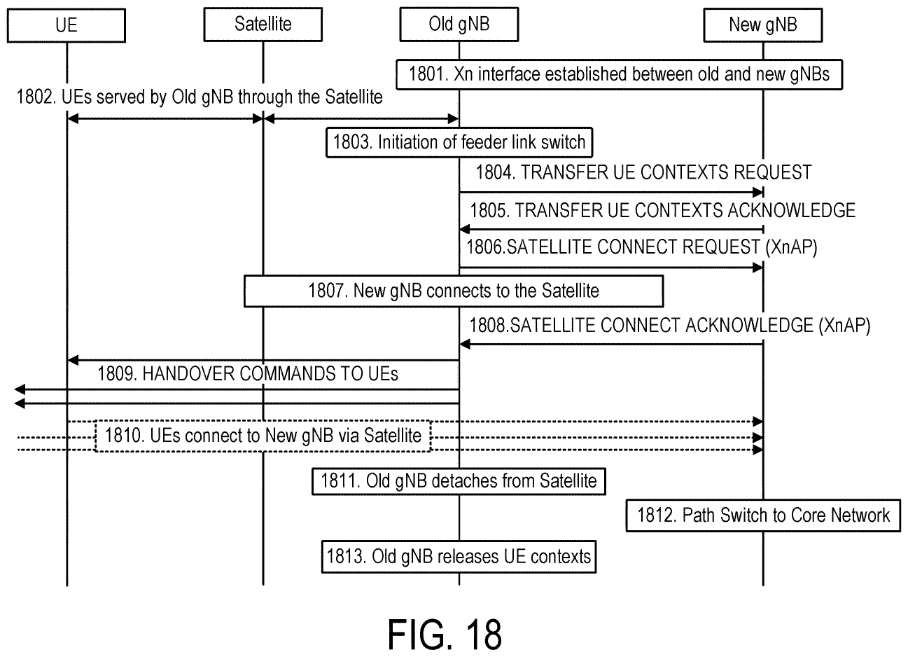

FIG. 17 shows a gNB Selection Procedure. Periodic measurements by neighboring gNBs of signal strength received from the satellite in question. Periodically, the old gNB sends, to each Candidate gNB, a SATELLITE MEASUREMENT REQUEST 1701. The request provides details of the satellite ephemeris and current location, and details on the satellite radio resources (e.g. free transponders) to connect to in order to assess coverage strength.

Each Candidate gNB receiving the request 1701 tunes in to the specified satellite radios for a specific amount of time and records the signal strength received from the satellite. The Candidate gNB sends a CONNECT TO SATELLITE AND MEASURE 1702 message to a satellite and records a measurement. The Candidate gNB responds to the source gNB with a SATELLITE MEASUREMENT RESPONSE 1703, which includes the signal strength measurement.

The source gNB loops through the process with all Candidate gNBs-preferably one at a time. The source gNB selects a Best Candidate gNB 1705 after comparing the measured signal strengths 1704. As an added safety bar, the selected gNB may be required to have recorded a signal strength of at least a certain amount over and above what the source gNB is receiving at the current moment from the satellite.

The new gNB may be selected based on learned information, e.g. knowledge of which gNBs have been selected near this location at this time of day-since these aspects may tend to cyclically repeat across days.

The selected gNB may be interrogated to determine its level of loading, to see if it has enough free capacity to accept this load of UEs. (The source gNB sends a RESOURCE STATUS REQUEST to the selected gNB, which responds with a RESOURCE STATUS UPDATE providing the capacity utilization information. These are currently defined XnAP messages).

If the selected gNB is seen to have insufficient capacity, the source gNB selects the next best (signal measurements wise) gNB from the candidate list. And so on . . . .

Steps 1701 to 1704 may be carried out during the “early trigger” phase, e.g. at threshold S1 described earlier.

TABLE 5
SATELLITE MEASUREMENT REQUEST Message Format
SATELLITE MEASUREMENT REQUEST Message:

| Field | Comments |
|---|---|
| Message Type | |
| Originating gNB ID | |
| Target gNB ID | |
| Satellite description | Ephemeris information etc. |
| Satellite radio resources | Satellite radio resources (transponders) |
| | to connect to, to measure |

TABLE 6
SATELLITE MEASUREMENT Response Message Format
SATELLITE MEASUREMENT RESPONSE Message:

| Field | Comments |
|---|---|
| Message Type | |
| Originating gNB ID | |
| Target gNB ID | |
| Satellite description | Ephemeris information etc. |
| Measurements | Radio signal strength measurements |

Olesen et al. describe in U.S. Pat. No. 12,068,793 that RAN node measurements include at least availability, efficiency, whether a device may be served a certain time period, traffic load, supported data rate, distance, channel condition and the like. U.S. Pat. No. 11,689,275 to Olesen et al. describes that a measurement may be taken based on a representative beam or an average of the beams of a group. U.S. Pat. Nos. 11,689,275 and 12,068,793 are reproduced herein by reference in their entirety.

A UE Context Transfer between source and target gNB nodes may be in bulk.

Per the current standards, each UE would need to be handed over to the target gNB. Given that an NTN gNB might have a large number of connected UEs, this one-by-one handover scheme would be a protracted process, taking a long time and incurring significant overheads for the RAN nodes. Additionally, this might result in some UEs' handovers not completing by the time the satellite loses sight of the original Gateway/gNB, and the UEs losing their RRC connections and having to establish RRC connections from scratch.

Instead of carrying out a handover process for each UE, in embodiments, transferring the contexts of the UEs over to the new gNB may be performed. This may be done in “bulk mode”, e.g. each TRANSFER UE CONTEXTS REQUEST may include context information for multiple UEs. Multiple TRANSFER UE CONTEXTS may be needed, but this process may still be a lot less cumbersome than performing individual handovers for potentially hundreds of UEs.

### “Bunched” UE Context Transfer Messages

Each TRANSFER UE CONTEXTS message would therefore include the information on a “bunch” of UEs. The UE population is divided into bunches. A first set of UEs’ context information is first sent to the new gNB, then a next set of UEs' contexts, and so on.

The following mechanisms are options for establishing these “bunches”. In order of weak signal strength from the source gNB. For example, the first bunch would be UEs with weakest signal strength received from the satellite/gNB, e.g. in most urgent need of completing the handover before loss of connection. Then, next, the next stronger set of UEs, and so on. Based on load balancing: examining the data flows carried by UEs and the loads they impose on the network. UEs may be bunched such that total loads are even across bunches, and so that some bunches do not pose significantly higher loads than others. Assigning higher priority (e.g. earlier handovers) to UEs with QoS-critical data flows, e.g. low-latency flows, Guaranteed Bit Rate (GBR) flows, etc. Creating randomized groups of UEs.

TABLE 7
TRANSFER UE CONTEXTS REQUEST Message Format
TRANSFER UE CONTEXTS REQUEST Message:

| Field | Sub-Field | Sub-Sub-Field | Comments |
|---|---|---|---|
| Message Type | | | |
| Cause | | | |
| GUAMI | | | Global AMF |
| | | | Identifier |
| Number of UEs | | | |
| (1 . . . n) | | | |
| UE Context | UE ID | | |
| Information (per | Source NG-RAN | | Allocated at the |
| UE) | node UE XnAP ID | | source NG-RAN |
| | reference | | node |
| | Target Cell Global | | |
| | Id | | |
| | NG-C UE | | Allocated at AMF |
| | associated | | on source gNB |
| | Signalling | | connection |
| | reference | | |
| | Signalling TNL | | AMF's IP address |
| | association | | at source NG-C |
| | address at source | | interface instance |
| | NG-C side | | |
| | UE Security | | |
| | Capabilities | | |
| | Access System | | |
| | Security | | |
| | Capabilities | | |
| | UE Aggregate | | To be used by |
| | Maximum Bit Rate | | target gNB for |
| | | | traffic shaping |
| | Number of PDU | | |
| | Sessions for this | | |
| | UE (1 . . . m) | | |
| | PDU Session | PDU Session ID | |
| | Information (per | S-NSSAI | Network Slice ID |
| | PDU Session of | UL NG-U UP TNL | Uplink UPF |
| | this UE) | Information at UPF | endpoint of the |
| | | | NG-U transport |
| | | | bearer. |
| | | PDU Session Type | |
| | | Number of QoS | |
| | | Flows for this PDU | |
| | | Session | |
| | | QoS Flow | QoS Flow ID, QoS |
| | | Information (per | Flow Parameters, |
| | | QoS Flow for this | matching radio |
| | | PDU Session) | bearer ID |
| | RRC Context | | |
| UE Context | | | NG-RAN Node ID, |
| Reference at the | | | UE XnAP ID |
| S-NG-RAN node | | | |
| (per UE) | | | |

The TRANSFER UE CONTEXTS message requests the target gNB to admit a specified set of UEs.

For each UE, needed information is provided to the target gNB, including the UE's PDU Sessions. For each PDU Session on the UE, information on the PDU Session is provided, including the QoS Flows on the PDU Session. For each QoS Flow on each PDU Session, information on the QoS Flow is provided.

The RRC Context field, which is also per UE, provides to the target gNB information on the radio resource management (RRM) configuration, radio bearer configurations, master/secondary cell group configurations and PDCP configuration-prevailing on the source gNB.

This message therefore readies the target gNB with all the configuration information (PDU Sessions, flows, bearers etc.) for each UE being handed over to it. The target gNB performs admission control, allocates resources and sets up the needed configurations to allow the UEs to continue on the target gNB where they left off on the source gNB.

TABLE 8
TRANSFER UE CONTEXTS ACKNOWLEDGE Message Format
TRANSFER UE CONTEXTS ACKNOWLEDGE Message:

| | | | |
|---|---|---|---|
| Field | Sub-Field | Sub-Sub-Field | Comments |

| | | |
|---|---|---|
| Message Type | | |
| Number of UEs | | |
| Admitted by target | | |
| gNB (1 . . . n) | | |
| UE Context | UE ID | |
| Information (per | Source NG-RAN | Allocated at the |
| Admitted UE) | node UE XnAP ID | source NG-RAN |
| | reference | node |
| | Target NG-RAN | Allocated at the |
| | node UE XnAP ID | target NG-RAN |
| | | node |
| | PDU Session | |
| | Resources | |
| | Admitted List | |
| | Target NG-RAN | Includes Handover |
| | node To Source | Command |
| | NG-RAN node | message as |
| | Transparent | defined in 3GPP |
| | Container | TS 38.331 |

The TRANSFER UE CONTEXTS ACKNOWLEDGE message is the response from the target gNB to the TRANSFER UE CONTEXTS REQUEST. It indicates how many, and which, UEs have been admitted into the target gNB from the original request. For each admitted UE, it indicates which PDU Session resources have been admitted.

For each UE, a transparent Handover Command container is provided. This Handover Command may be sent by the source gNB to the UE to command the UE to move to the target gNB. This provides all the details for the UE to be able to connect to the target gNB.

Non-admission of UEs by target gNB:
The TRANSFER UE CONTEXTS RESPONSE message tells the source gNB which UEs from the requested list may be admitted into the target gNB. If there are UEs that cannot be admitted, the source gNB may pursue one of the following strategies. Cancel the ongoing handover by sending a HANDOVER CANCEL message (standard XnAP message) to the target gNB. Select another gNB (using the methodology above) to handover all UEs to, and restart steps 4 and 5 in the flow (TRANSFER UE CONTEXTS REQUEST). Or, handover the remaining (unadmitted) UEs to another gNB, if the architecture allows a satellite to be served by multiple gNBs. Continue with the ongoing handover for the admitted UEs.

### Bunched Handover Commands

We recommend also sending Handover Commands to UEs in bunches, so as not to create a signaling traffic flood in the network.

This bunching of Handover Commands is recommended to be on the lines of the UE Context Transfer bunching. The first bunch of UEs receiving Handover Commands would be the first bunch whose UE Contexts had been sent to the new gNB. The next bunch to receive Handover Commands would be the UEs whose context information was next sent to the new gNB. And so on . . . . Essentially, when a TRANSFER UE CONTEXT ACKNOWLEDGE is received by the old gNB, it may issue Handover Commands for the set of UEs addressed by that TRANSFER UE CONTEXT exchange.

TABLE 9
SATELLITE CONNECT REQUEST Message Format
SATELLITE CONNECT REQUEST Message:

| Field | Comments |
|---|---|
| Message Type | |
| Originating gNB ID | |
| Target gNB ID | |
| Satellite description | Ephemeris information etc. |
| Satellite radio resources | Satellite radio resources (transponders) |
| | to connect to |

TABLE 10
SATELLITE CONNECT ACKNOWLEDGE Message Format
SATELLITE CONNECT ACKNOWLEDGE Message:

| Field | Comments |
|---|---|
| Message Type | |
| Originating gNB ID | |
| Target gNB ID | |
| Satellite description | Ephemeris information etc. |
| Result | Success or Failure |
| Cause | Failure Cause (if failed) |

Satellite connection error at target gNB:
If the target gNB is unable to connect to the satellite for some reason (e.g. a SATELLITE CONNECT FAILURE message is received from the target gNB, or the SATELLITE CONNECT REQUEST times out): the source gNB cancels the ongoing handover by sending a HANDOVER CANCEL message to the target gNB. The source gNB may select another gNB (using the methodology above) to handover all UEs to, and restart steps 4 and 5 in the flow (TRANSFER UE CONTEXTS REQUEST).

### Timed, Bunched Handover Completion

It is also proposed here to conditionally time the handover for each UE, to control when each UE accesses the target gNB. A UE may lose connection to the old gNB at step 7 in the message flow above, when the old gNB detaches from the satellite. Every UE should be timed to access the new gNB at a time after the new gNB connects to the satellite (step 9 in the flow above). This timing should be indicated in the Handover Command to each UE.

The times should also be staggered in bunches, e.g. a bunch of first UEs are asked to connect to the new gNB at a certain point in time; the next set of UEs at a slightly later point in time; etc. This is in order to avoid severe congestion and contention from a flood of UE accesses.

US patenttent Publication no. 20080013528 and US patenttent Publication no. 20040148352 to Menon et al., reproduced herein by reference in their entirety, describe various methods for determining, detecting and preventing cell congestion which may be used in combination with embodiments disclosed herein.

This bunching of handover completions is recommended to be on the lines of the Handover Command bunching. The first bunch of UEs receiving Handover Commands may be the first bunch to complete handovers, and may be given the earliest time range to connect to the new gNB and complete handover. The next bunch to receive Handover Commands would be given the next (later) time range to complete handovers within. And so on . . . .

Handover Cancellation Late in the Flow:
If the ongoing handover needs to be canceled late in the flow (after the target gNB has connected to the satellite): the source gNB: sends a SATELLITE DISCONNECT REQUEST to the target gNB, to which the target gNB responds with a SATELLITE DISCONNECT ACKNOWLEDGE; sends a HANDOVER CANCEL to the target gNB.

TABLE 11
SATELLITE DISCONNECT REQUEST Message Format
SATELLITE DISCONNECT REQUEST Message:

| Field | Comments |
|---|---|
| Message Type | |
| Originating gNB ID | |
| Target gNB ID | |
| Satellite description | Ephemeris information etc. |

TABLE 12
SATELLITE DISCONNECT ACKNOWLEDGE Message Format
SATELLITE DISCONNECT ACKNOWLEDGE Message:

| Field | Comments |
|---|---|
| Message Type | |
| Originating gNB ID | |
| Target gNB ID | |
| Satellite description | Ephemeris information etc. |

FIG. 18 proposes an end-end procedure for feeder link switchover for a transparent architecture. This flow is for a soft switchover, e.g. the satellite is connected to both old and new one Gateways/gNBs at a time during the switchover.

Step 1801 To start with, the old (existing) gNB detects that the satellite is moving farther from the gNB, and that a feeder link switchover is imminent. The old gNB has identified a target (new) gNB and Gateway that the satellite should switch the feeder link to, based on the satellite's movement.

Step 1802 UEs are served by the old gNB, via the satellite.

Step 1803 The old gNB makes a decision to switch the satellite to the new Gateway and gNB, sensing that given the satellite's position and movement, a break in the feeder link is imminent.

Step 1804 The old gNB sends a TRANSFER UE CONTEXTS REQUEST message to the new gNB. This transfers the complete contexts of all UEs known by the old gNB (UEs with any context information in the gNB). This includes RRC state information, PDU session and QoS Flow information, radio bearer information and other state and session information maintained at the PDCP and RLC layers. The idea here is to equip the new gNB with all state and session information for all UEs transferring over, so that the sessions, flows and bearers may be continued seamlessly at the new gNB.

Step 1805 The new gNB performs admission control, stores the UEs' context information and returns a TRANSFER UE CONTEXTS ACKNOWLEDGE message to the old gNB. This message indicates the new gNB has reserved resources to admit the UEs, and is willing to support the handover.

Step 1806 The old gNB sends a SATELLITE CONNECT REQUEST to the new gNB. This may be a new message in the XnAP (Xn control) protocol.

Step 1807 The new gNB connects to the satellite.

Step 1808 The new gNB sends a SATELLITE CONNECT ACKNOWLEDGE message (XnAP) back to the old gNB.

Step 1809 The old gNB issues HANDOVER COMMAND messages to all the UEs. (These may be bunched up to avoid creating congestion by sending all of them at once).

Step 1810 UEs now connect via the satellite to the new gNB.

Step 1811 The old gNB detaches from the satellite.

Step 1812 A path switch is worked out with the Core Network, so that downlink data may now be routed by the CN to the new gNB.

Step 1813 The old gNB releases all UE contexts.

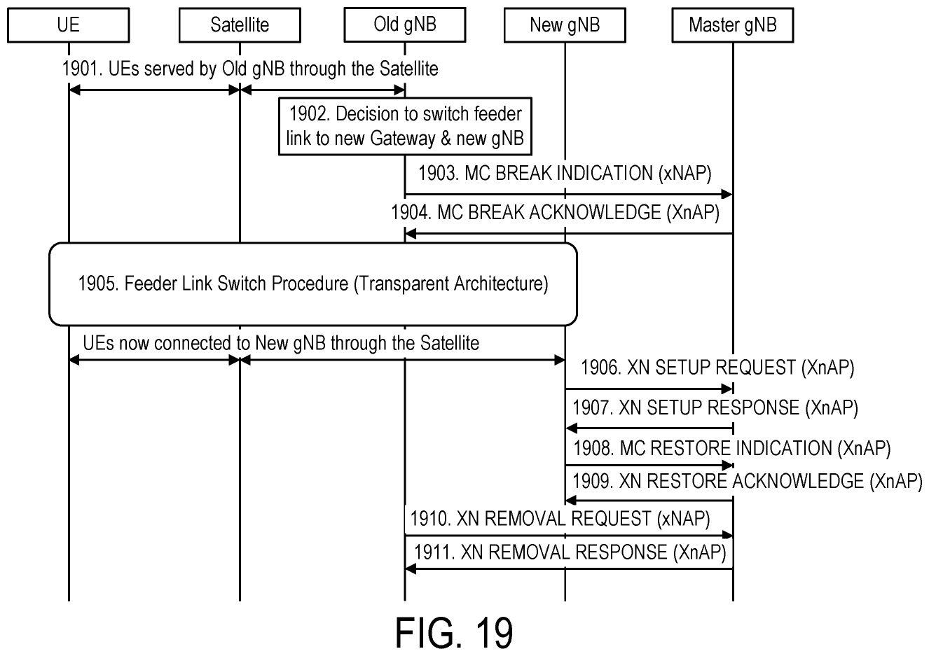

FIG. 19 shows the interactions of the feeder link switch procedure (transparent architecture) with multi-connectivity, e.g. the case where the NTN system undergoing the feeder link switch is multi-connected to a Master gNB in another network (a TN system or another NTN constellation).

Step 1901 UEs are served via the satellite by the old gNB. The Xn interface for multi-connectivity is established between the old gNB and Master gNB in the second network (TN in this example).

Step 1902 The old gNB decides to do the feeder link switch.

Step 1903 The old gNB sends a Multi-Connection (MC) BREAK INDICATION (new XnAP message) to the Master gNB, in anticipation of the feeder link switch, and a break in the NTN delivery path, occurring.

Step 1904 The Master gNB responds with a MC BREAK ACKNOWLEDGE (new XnAP message) to the old gNB. In response to the BREAK INDICATION, the Master gNB may make adjustments and re-routes to data flows (bearers) traversing the multi-connection (see paragraphs below).

Step 1905 The feeder link switchover procedure is carried out.

Step 1906 The new gNB sends a XN SETUP REQUEST (existing XnAP message) to the Master gNB.

Step 1907 The Master gNB responds with a XN SETUP RESPONSE. The Xn interface is now reestablished for the multi-connection, but between the new gNB and Master gNB.

Step 1908 The new gNB sends a Multi-Connection (MC) RESTORE INDICATION (new XnAP message) to the Master gNB over the newly established Xn interface, indicating that the NTN delivery path is back up through the new NTN gNB and Gateway.

Step 1909 The Master gNB returns a MC RESTORE ACKNOWLEDGE (new XnAP message) to the new gNB. The Master gNB may, at this point, restore the multi-connected data flow bearers back to their original states before the break.

Step 1910 The old gNB sends a XN REMOVAL REQUEST (existing XnAP message) to the Master gNB. This is done to release the old multi-connectivity Xn interface between old gNB and Master gNB.

Step 1911 The Master gNB releases the Xn interface and all resources related to the Xn, and responds with a XN REMOVAL RESPONSE message. The old gNB releases the old Xn and all its Xn resources.

### Feeder Link Switchover (Regenerative Architecture)

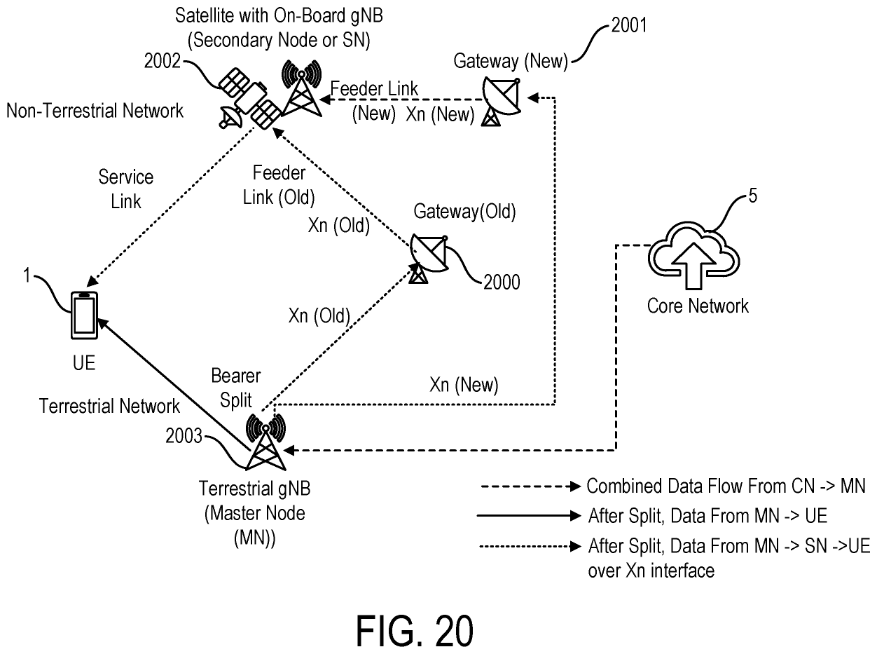

FIG. 20 illustrates a feeder link switchover for a regenerative NTN system. Here, the gNB 2002 is on-board the satellite, hence no change of gNB 2002 occurs. The satellite/gNB 2002 moves from the old Gateway 2000 to the new Gateway 2001. The gNB 2002 may incur a change of IP address-having to be allocated an IP address from the address space of the Gateway.

FIG. 20 also includes a multi-connection scenario, showing the NTN multi-connected to a terrestrial 5G system including terrestrial gNB MN 2003. The pre-existing Xn interface between gNB (NTN) 2002 and Master (TN) gNB 2003 traverses the old Gateway 2000 and the feeder link. Hence, the Xn gets broken when the feeder link switch occurs. The Xn gets reestablished between the NTN gNB 2002 and Master gNB 2003 via the new Gateway 2001 at the end of the procedure.

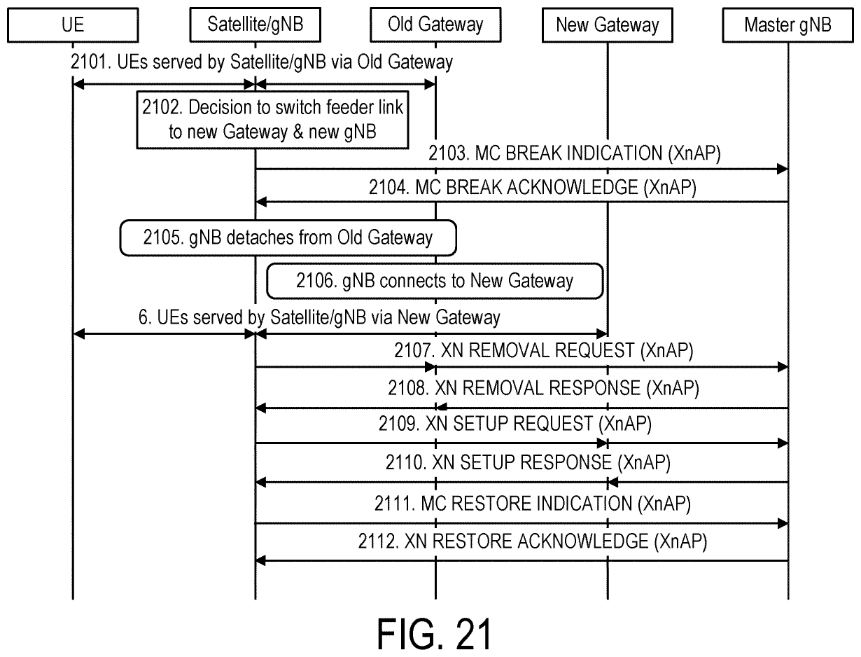

FIG. 21 demonstrates an end-end procedure for feeder link switchover for a regenerative architecture.

Step 2101 The Xn interface for multi-connectivity is established between the NTN gNB and Master gNB in the second network (TN in this example), via the old Gateway. UEs in the NTN are served by the satellite/gNB via the old Gateway.

Step 2102 The NTN gNB makes a decision to do a feeder link switchover.

Step 2103 The NTN gNB sends a Multi-Connection (MC) BREAK INDICATION (new XnAP message) to the Master gNB, in anticipation of the feeder link switch, and a break in the NTN delivery path, occurring.

Step 2104 The Master gNB responds with a MC BREAK ACKNOWLEDGE (new XnAP message) to the NTN gNB. In response to the BREAK INDICATION, the Master gNB may make adjustments and re-routes to data flows (bearers) traversing the multi-connection (see paragraphs below).

Step 2105 The NTN gNB detaches from the old Gateway.

Step 2106 The NTN gNB connects to the new Gateway. UEs are now connected through the satellite/gNB to the new Gateway.

Step 2107 The NTN gNB sends a XN REMOVAL REQUEST (existing XnAP message) to the Master gNB. This is done to release the current multi-connectivity Xn interface.

Step 2108 The Master gNB releases the Xn interface and all resources related to the Xn, and responds with a XN REMOVAL RESPONSE message. The NTN gNB releases the Xn and all its Xn resources.

Step 2109 The NTN gNB sends a XN SETUP REQUEST (existing XnAP message) to the Master gNB. This goes through the new Gateway.

Step 2110 The Master gNB responds with a XN SETUP RESPONSE. The Xn interface is now reestablished for the multi-connection, but through the new Gateway.

Step 2111 The NTN gNB sends a Multi-Connection (MC) RESTORE INDICATION (new XnAP message) to the Master gNB over the newly established Xn interface, indicating that the NTN delivery path is back up through the new Gateway.

Step 2112 The Master gNB returns a MC RESTORE ACKNOWLEDGE (new XnAP message) to the NTN gNB. The Master gNB may, at this point, restore the multi-connected data flow bearers back to their original states.

### RAN Actions in Response in the Partner Network

In response to a feeder link switchover in the NTN, the RAN in the partner network (the multi-connected TN or NTN) may be required to take steps to buffer or reroute different data flows. In our above example, the partner network is the connected TN with the Master gNB.

Master gNB response to MC BREAK INDICATION:
A trigger to the Master Node may be the XnAP message MC BREAK INDICATION. The Master Node, on receiving this, may perform one or more of the following. For any Split Bearer running through MN and SN, disable the leg delivering through the NTN. Since the Xn interface is expected to be down, and the Xn is required to steer data from the MN through the SN, this may make sense to do. (Refer to FIG. 15 for background). For any MN-terminated SCG Bearer (e.g. bearer that is Core Network terminated at the MN but is delivered using SN radio resources- and hence flows over the Xn), there are two alternatives: Halt and buffer the data flow at the Master Node. Or, move the data flow over to the Master Node, e.g. convert it into an MN-terminated MCG Bearer. In this case, the Master gNB may be required to also reconfigure the UE with an RRC Reconfiguration Request, and do a Path Switch on the Core Network to route downlink data on this bearer to the Master gNB. Optionally, for any SN-terminated SCG Bearer flows on the NTN gNB: move the data flows over to the Master gNB, e.g. convert to MN-terminated MCG Bearers. Reconfigure the UE, and perform path switches on the Core Network.

Master gNB response to MC RESTORE INDICATION:
The data flows may revert to their original states when the Xn interface is reestablished at the conclusion of the feeder link switch procedure.

### Basic NTN Operation—Service Link Handover

The service link is the other significant link in the NTN architecture, and provides the important connection of the UE to the satellite. The UE may be handed over from one satellite to another (e.g. service link changes) as the UE's connection to the original satellite fades and the new satellite presents a much stronger connection. With the transparent architecture, this may mean a gNB change (e.g. inter-gNB handover) or no gNB change (intra-gNB handover). With the regenerative architecture, since the gNB is on-board the satellite, there is always a gNB change.

One difference from the feeder link switchover scenario here is that there is a change in satellite involved, e.g. UEs move from one satellite to another.

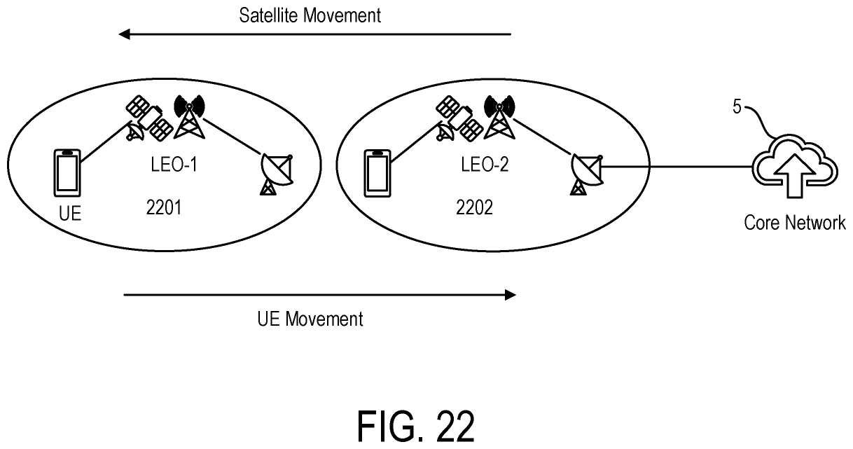

FIG. 22 illustrates a Feeder Link Switchover (Regenerative Architecture)—with Multi-Connectivity. Service link handover may be triggered by two types of mobility. UE mobility: in FIG. 22, UE mobility (e.g. a UE in a moving car) might move the UE from the coverage area of LEO-1 2201 to that of the coverage area of LEO-2 2202. If the UE is in RRC-CONNECTED state, a handover may gracefully move the UE to a cell 2202 covered by LEO-2 (and its gNB). This is a single UE specific scenario, e.g. the handover handles a specific UE's mobility. Satellite mobility: satellite movement may periodically force all RRC-CONNECTED UEs in a given area to be handed over from satellite to satellite. In FIG. 22, the eventual replacement of LEO-1's coverage 2201, of the area to the left, by that of LEO-2 2202 means that all UEs in that area may need to be handed over to LEO-2 (and its gNB). This satellite mobility driven handover is not a single UE specific scenario, and it applies all RRC-CONNECTED UEs in a given area. This is typically expected to happen in an area every 10-15 minutes in a LEO system.

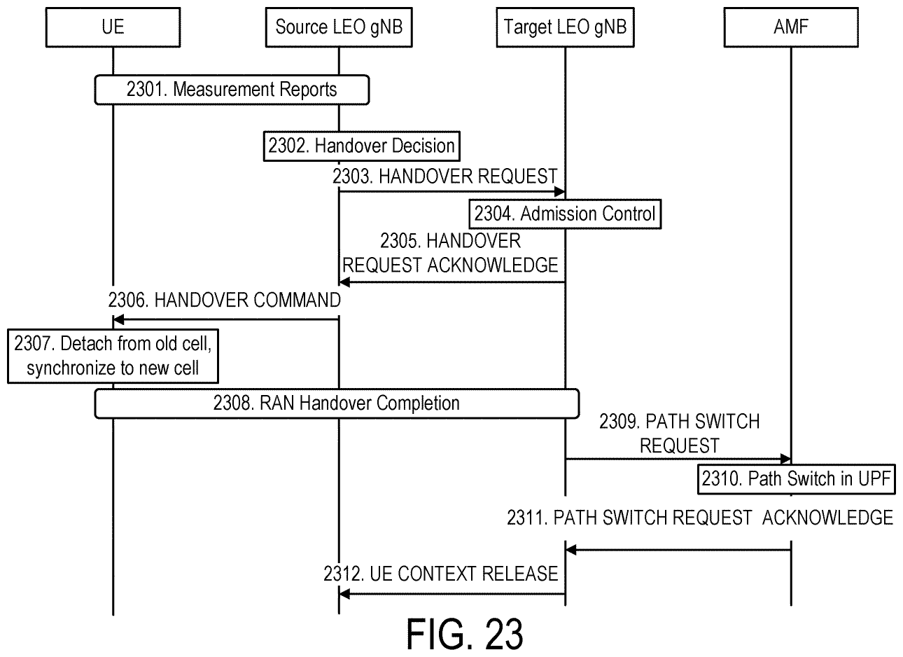

FIG. 23 shows a baseline flow for UE access link handover. This may be performed on a UE-specific basis. In an NTN, this flow may be applied to a handover triggered by UE mobility, since that would be on a UE-by-UE basis.

Specifically, FIG. 23 shows a UE supplying measurement reports 2301 to a source gNB. The source gNB makes a handover decision 2302 and sends a HANDOVER REQUEST 2303 to a target gNB which performs admission control 2304. The target gNB sends a HANDOVER REQUEST ACK 2305 to the source gNB which provides a HANDOVER COMMAND 2306 to the UE. The UE detaches 2307 from the old cell and synchronizes with the new cell. RAN Handover completion 2308 is performed and a PATH SWITCH REQUEST 2309 is sent from the target gNB to the AMF. A path switch 2310 occurs in the UPF and the AMF ACKs 2311 the PATH SWITCH REQUEST to the target gNB. A UE CONTEXT RELEASE 2312 is provided to the source gNB.

For handover triggered by satellite mobility (where a large number of UEs need to be handed over in a short period of time), doing this UE-by-UE may have significant issues. Given the much larger area of coverage of an NTN gNB (compared to a terrestrial gNB), there could be hundreds (potentially thousands) of UEs that need to be handed over to the new satellite/gNB as the new satellite moves in to replace the source satellite's coverage of the area. Eventually, every one of the UEs under the satellite may need to be moved to the new satellite/gNB on a new service link. The handovers may need to be completed in a finite amount of time. The time taken for each handover would typically be longer than for a terrestrial handover. Every signaling step that traverses a satellite link (feeder or service link) takes longer than its counterpart in a terrestrial system.

If the handover is performed the standard 3GPP way, this may result in: Overhead and heavy load for the RAN; a large amount of time taken; significant break in service continuity; Inability for several UEs to complete handover by the time these UEs lose sight of the satellite, resulting in radio link failures for the UEs. If UEs lose their connections with the satellite before receiving Handover Commands (e.g. before Step 2306 in FIG. 23), these UEs may not be able to complete handover. They may then experience radio link failures, resulting in a time-consuming radio reset process. These UEs would then have to set up RRC connections all over again with a new gNB.

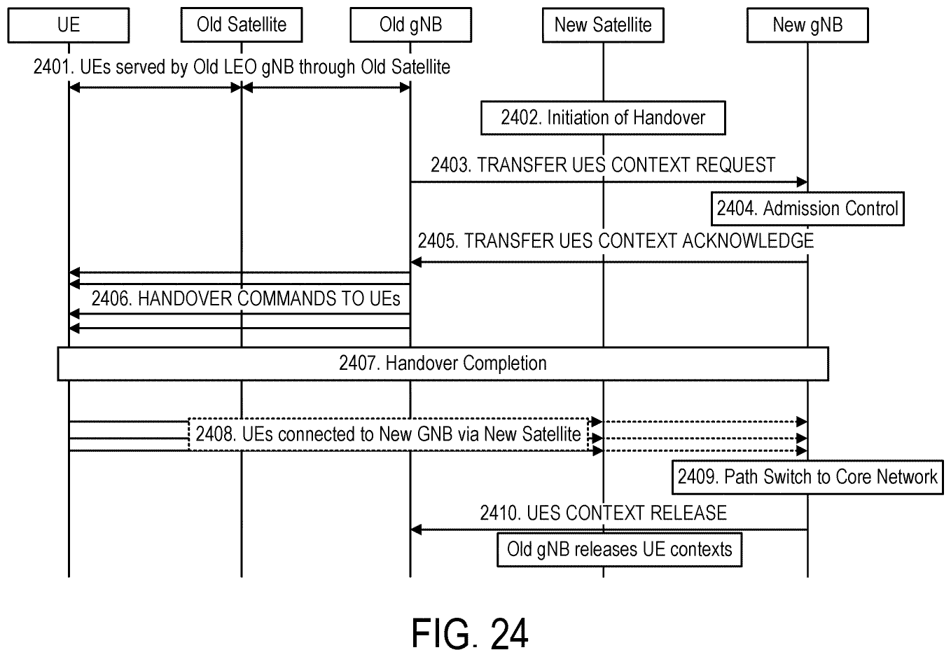

FIG. 24 proposes an improved service link handover flow for NTN systems, for a scenario driven by satellite mobility—one that addresses the issues described previously.

Step 2401 The initial state has UEs being served by the source LEO satellite and its gNB (“old gNB”).

Step 2402 The old gNB decides to initiate handover, determining that the UEs in the area are shortly going to lose sight of the source satellite (new satellite taking over coverage of the area shortly).

Step 2403 The old gNB sends a TRANSFER UE CONTEXTS REQUEST message to the new gNB connected to the new satellite. This transfers the complete contexts of a bunch of UEs to the new gNB. This includes RRC state information, PDU session and QoS Flow information, radio bearer information and other state and session information maintained at the PDCP and RLC layers. The idea here is to equip the new gNB with all state and session information for a group of UEs transferring over, so that the sessions, flows and bearers may be continued seamlessly at the new gNB.

Step 2404 The new gNB performs admission control, and stores the UEs' context information.

Step 2405 The new gNB returns a TRANSFER UE CONTEXTS ACKNOWLEDGE message to the old gNB. This message indicates the new gNB has reserved resources to admit the UEs, and is willing to support the handover.

Step 2406 The old gNB issues HANDOVER COMMAND messages to this bunch of UEs. Each UE is provided a time in the HANDOVER COMMAND at which it is expected to complete the handover, e.g. connect to the new gNB and complete the procedure.

Step 2407 These UEs now complete handover, by connecting to the new satellite/gNB, to the correct cells as specified in the HANDOVER COMMANDS.

Step 2408 These UEs are now connected (still in RRC-CONNECTED state) via the new satellite to the new gNB.

Step 2409 A path switch is worked out with the Core Network, so that downlink data may now be routed by the CN to the new gNB.

Step 2410 The old gNB releases UE contexts for this bunch of UEs.

Triggers for start of service link switch procedure:
The first step is for the source gNB to determine the need for a handover-driven by satellite mobility. The source gNB determines that due to the satellite constellation's mobility, the source satellite is shortly going to be out of range of at least some of the UEs in the area (and eventually most or all of the UEs). The job of the handover is to place these UEs on the strongest next satellite coming through to provide coverage over the area.
This is a different trigger from a UE-specific handover scenario, triggered by a UE's mobility. The source gNB determines that the constellation's mobility is going to force all the UEs to get handed over (“crowd handover” scenario). Of course, all of the UEs may not experience signal degradation at once-so the deterioration in coverage, and the handover of the UEs, may likely happen in “bunches”.

When the first set of UEs report diminished coverage from the source satellite, and stronger signals from neighboring gNBs, the source gNB may conclude that this is a “crowd handover” scenario due to satellite mobility. (If initially, only a couple of UEs exhibit this, the source gNB waits to see if additional UEs join the list; if that does not happen, the source gNB may pursue a “one-by-one” handover strategy, e.g. conclude this is a result of those UEs' mobility).

That first set of UEs becomes the first set that is addressed in the TRANSFER UE CONTEXTS exchange. As other UEs subsequently report in similarly, additional UE sets are created and addressed in the protocol exchanges. Hence, the “bunching” here is formed on an as-needed basis.

The triggers may be also be learned over time using machine learning models. Satellite movement may tend to be cyclical, and may exhibit repetitive patterns in terms of when and where the satellite is when handover thresholds are crossed. The gNB may use this knowledge to predictively determine when to trigger the procedure.

The gNB may use a combination of the predictive and measurement oriented data to determine when to trigger the service link handover.

Selection of new satellite/gNB:
Multiple methods may be leveraged by the old gNB to select a new satellite/gNB to switch the satellite's feeder link to: monitor neighboring gNBs; select the new gNB; use a combination of measurement/learned approach; interrogate the selected gNB.
Neighboring gNBs may be monitored based on measurements reported by UEs. Candidate new gNBs may be selected for which a critical mass of the UEs report significantly higher measurements of signal strength (relative to the source gNB). Out of these, select the gNB with the strongest reported measurements.
Note that the selected gNB, in this form of “crowd handover”, may apply to all of the UEs moving over. (Unlike the per-UE case, where each UE might have its own target gNB).

The new gNB may be selected based on learned information, e.g. knowledge of which gNBs have been selected near this location at this time of day-since these aspects may tend to cyclically repeat across days.

A combination of measurement and learned approaches may be used to select the gNB. The selected gNB may be interrogated to determine its level of loading, to see if it has enough free capacity to accept this load of UEs. (The source gNB sends a RESOURCE STATUS REQUEST to the selected gNB, which responds with a RESOURCE STATUS UPDATE providing the capacity utilization information. These are currently defined XnAP messages).

If the selected gNB is seen to have insufficient capacity, the source gNB selects the next best (signal measurements wise) gNB from the candidate list. And so on . . . .

Early triggering:
The source gNB may start the handover triggering process early, e.g. prepare lists of UEs (based on the UE contexts known to the source gNB) and provide early TRANSFER UE CONTEXTS messages to the target gNB. This may be done to reduce the signaling traffic load and processing, and to save time and effort, at the actual time of handover. Handover Commands are then prepared by the source gNB, but delivered to the UEs only at the time of handover.

### Bulk UE Context Transfer Between Source and Target gNB Nodes

Per the current standards, each UE would need to be handed over to the target gNB. Given that an NTN gNB is likely to have a large number of connected UEs, this one-by-one handover scheme would be a protracted process, taking a long time and incurring significant overheads for the RAN nodes. Additionally, this might result in some UEs' handovers not completing by the time the UEs lose sight of the source satellite, and the UEs losing their RRC connections and having to establish RRC connections from scratch.

Instead of carrying out a handover process for each UE, we propose simply transferring the contexts of the UEs over to the new gNB. This may be done in “bulk mode”, e.g. each TRANSFER UE CONTEXTS REQUEST may include context information for multiple UEs. Multiple TRANSFER UE CONTEXTS messages may be needed, but this process may still be a lot less cumbersome than performing individual handovers for potentially hundreds of UEs.

If the target gNB cannot accommodate all UEs:
The TRANSFER UE CONTEXTS RESPONSE message tells the source gNB which UEs from the requested list may be admitted into the target gNB. If there are UEs that cannot be admitted, the source gNB may select another satellite/gNB (using the methodology above) to handover all remaining UEs to.

### Bunched Handover Commands

Sending Handover Commands to UEs in bunches may be performed, so as not to create a signaling traffic flood in the network.

This bunching of Handover Commands is recommended to be on the lines of the UE Context Transfer bunching. The first bunch of UEs receiving Handover Commands would be the first bunch whose UE Contexts had been sent to the new gNB. The next bunch to receive Handover Commands would be the UEs whose context information was next sent to the new gNB. And so on . . . . Essentially, when a TRANSFER UE CONTEXT ACKNOWLEDGE is received by the old gNB, it may issue Handover Commands for the set of UEs addressed by that TRANSFER UE CONTEXT exchange.

Timed, Bunched handover completion:
It is also proposed herein to conditionally time the handover for each UE, to control when each UE accesses the target gNB. This timing should be indicated in the Handover Command to each UE, to stagger the UEs' accesses to the new gNB. This is in order to avoid severe congestion and contention from a flood of UE accesses.
This bunching of handover completions is recommended to be on the lines of the Handover Command bunching. The first bunch of UEs receiving Handover Commands would be the first bunch to complete handovers, and would be given the earliest time range to connect to the new gNB and complete handover. The next bunch to receive Handover Commands would be given the next (later) time range to complete handovers within. And so on . . . .

Cancellation of Handover at any stage:
The source gNB may cancel the ongoing handover by sending a HANDOVER CANCEL (existing XnAP) message to the target gNB.

A method for satellite network mobility may comprise a device communicating data through a wireless network via a first connection to a first satellite; the device predicting a future loss of connection to the first satellite; the device selecting a second satellite to move to out of the candidate satellites on the different visible orbital planes; the device requesting the network to enable establishment of a second connection from the device to the selected second satellite, in a multi-connection configuration including the device's first connection to the first satellite; the device's request to the network indicating the identity of the selected second satellite as the second satellite to connect to the device establishing a second connection to the second satellite, simultaneous with the device's first connection with the first satellite; (in embodiments, the wireless device selects a next satellite and provides that information to the network) as part of the multi-connection setup, the device's data flows getting moved (from the first satellite to the second satellite, or being split across the paths through the two satellites; subsequently, the device providing an indication to the network of imminent loss of the service link to the first satellite; the device releasing its connection to the first satellite and staying on the second satellite.

The satellite network is a low earth orbit system. The satellite network is a medium earth orbit system. The connection loss prediction trigger is based on historical knowledge of where and when connection losses have occurred. The connection loss prediction trigger is based on analysis of the satellite system's orbital path to determine when and where the next connection break is likely to occur. The connection loss prediction trigger is based on a combination of approaches: historical knowledge, analysis of orbital path, device measurements of signal strength, and time/location information. The selection of the second satellite is based on the device's measurements of signal strengths received from candidate neighboring satellites. The selection of the second satellite is based on prior knowledge of satellites selected at the given time and location. The device uses knowledge of its activated data flows, and the quality of service requirements of the data flows, to select the best second satellite out of the candidate list of neighboring satellites. First and second satellites are attached to a same gNB (note that the term gNB is used here for simplicity any may refer to a 5G node B, 6G node B or another version node B). Multiple simultaneous connections are established using a carrier aggregation configuration. The first and second satellites are attached to different gNBs. Multiple simultaneous connections are established using a multi-connection configuration. The connected network is a 5G network. The connected network is a 6G network. The first satellite is a transparent satellite. The first satellite is a regenerative satellite. The second satellite is a transparent satellite. The second satellite is a regenerative satellite.

A method for an extended periodicity of half frames with synchronization signal physical broadcast channel (SS/PBCH) blocks during initial access, access of SCELL or during handover; wherein the extended periodicity may include one or mode of {20 ms, 40 ms, 80 ms, 160 ms, 320 ms, 640 ms}.

A UE supporting SIB1 PDSCH coverage enhancements may assume that the PDCCH and associated PDSCH are repeated in both SS/PBCH slots where the corresponding PDCCHs are transmitted. Each NTN band may be assigned a default SSB periodicity, for example, at least one of: {20 ms, 40 ms, 80 ms, 160 ms, 320 ms, or 640 ms}. When operating in NTN bands, the UE(s) may assume that the default SSB periodicity is 160 ms. A plurality of cells transmit SS/PBCH, wherein the plurality of cells are on the same gNB. A plurality of cells transmit SS/PBCH on different gNBs in a multi connectivity environment. Extended and flexible SSB periodicity levels are used in the second satellite gNB while the multi-connection is active. An on-demand SSB mechanism is used in the second satellite gNB while the multi-connection is active, wherein a device performs measurements on the SSB in order to provide information and effectuate mobility of the device. The use of flexible or extended or on-demand SSB mechanisms reduces overhead in the second satellite and the underlying devices connected to it. A device connected to a second satellite in multi-connection mode conserves energy by going into sleep mode during the longer intervals between SSB occasions.

A user equipment (UE) comprising: a transceiver and circuitry; the transceiver configured to discover a terrestrial (TN) network node and a (NTN) non-terrestrial network node. The transceiver is connected to the TN network node and the NTN network node in a multi-connectivity configuration. The UE multi-connectivity configuration includes the integration of two or more NTNs, e.g. a LEO NTN network with a GEO NTN network, each network comprising one or more satellites. The UE operates in a transparent NTN architecture comprising a satellite, ground gateway and on-ground gNB. A master node of the transparent NTN architecture implements SDAP, PDCP, RLC MAC and PHY layers, wherein a secondary node of the transparent NTN architecture implements SDAP, PDCP, RLC MAC and PHY layers.

35. The method of any one of the preceding claims, wherein PDCP PDUs of the master node are provided to the secondary node for transmission, wherein PDCP PDUs of the secondary node are provided to the master node, wherein the UE and/or another UE receives flows originated by the master node via the master node and/or the secondary node. Control plane access and the connection to the Core network are only provided to the UE through the MN (TN gNB).

A method for feeder link switchover, may comprise detecting, by an old (existing) gNB that a satellite is moving farther from the gNB, and that a feeder link switchover is imminent; identifying, by the old gNB a target (new) gNB and Gateway that the satellite should switch the feeder link to, based on the satellite's movement; serving, by the old gNB, UEs, via the satellite.

Determining, by the old gNB, to switch the satellite to the new gateway and gNB, sensing that given the satellite's position and movement, a break in the feeder link is imminent; sending, by the old gNB a TRANSFER UE CONTEXTS REQUEST message to the new gNB, wherein TRANSFER UE CONTEXTS REQUEST message transfers the complete contexts of all UEs known by the old gNB (UEs with any context information in the gNB) to the new gNB, including RRC state information, PDU session and QoS Flow information, radio bearer information and other state and session information maintained at the PDCP and RLC layers, wherein the new gNB is equipped with all state and session information for all UEs transferring over, so that the sessions, flows and bearers may be continued seamlessly at the new gNB; performing admission control, by the new gNB, and storing the UEs' context information and returning a TRANSFER UE CONTEXTS ACKNOWLEDGE message to the old gNB, wherein the TRANSFER UE CONTEXTS ACKNOWLEDGE message indicates the new gNB has reserved resources to admit the UEs, and is willing to support the handover; issuing, by the old gNB, one or more HANDOVER COMMAND messages to all the UEs, wherein, in embodiments, the HANDOVER COMMAND MESSAGES are bunched (e.g. sent to a group of UEs, waiting a preconfigured or defined delay and then sent to another group of UEs) to avoid creating congestion by sending all of them at once, wherein each UE is provided a time (which may be implemented as a system time, duration or the like) in the HANDOVER COMMAND at which it is expected to complete the handover, e.g. connect to the new gNB and complete the procedure; detaching, by the old gNB, from the satellite; sending, by the old gNB, a SATELLITE CONNECT REQUEST to the new gNB, wherein the SATELLITE CONNECT REQUEST is a new message in the XnAP (Xn control) protocol; connecting, by the new gNB, to the new satellite; sending, by the new gNB, a SATELLITE CONNECT ACKNOWLEDGE message (XnAP) back to the old gNB; connecting, by the UEs, via the satellite to the new gNB; configuring a path switch with the Core Network, so that downlink data may now be routed by the CN to the new gNB; releasing, by the old gNB, all UE contexts.

The new gNB is selected such that it has a higher capacity than another gNB in the TN.

A satellite is simultaneously connected to a plurality of gNBs in steady-state.

A method of triggering a feeder link switch procedure, the method comprising: determining, by an old gNB, a need for switchover, based on any one or more of the following triggers: a signal strength dropping below an initial threshold (S1); a feeder link signal strength drops below a second threshold (S2); wherein S1 and S2 are learned over time using machine learning models; gNB using a combination of the predictive and measurement oriented data to determine when to trigger the feeder link switch.

A method for selecting a new gNB and optionally a new gateway, the method comprising, selecting one or more of the following: assembling a list of candidate gNBs from neighbor gNB information and/or knowledge of which gNBs have been used with the satellite in the area on past days, such information may come from network nodes (e.g. core network nodes) or base stations (e.g. terrestrial or ntn); selecting a new gNB based on learned information; sending a request for load level and receiving a response (to from any node described herein) comprising a requested load level; and if the selected gNB is seen to have insufficient capacity, the source gNB selects the next best (signal measurements wise) gNB from the candidate list.

A method comprising: sending a SATELLITE MEASUREMENT REQUEST message from an old gNB to a candidate gNB; selecting and measuring by the candidate gNB at least one parameter of the satellite; and receiving a SATELLITE MEASUREMENT RESPONSE message; wherein a new gNB is selected based on the a SATELLITE MEASUREMENT RESPONSE message content.

A bunching method comprising: dividing a population of UEs into groups (e.g. bunches); transmitting one or more TRANSFER UE CONTEXTS messages including information on a group of UEs; sending context information pertaining to a first set of UEs, to a new gNB; delaying a period of time, based on a delay; sending a next set of UEs' contexts information after the delay period. Bunching is performed in order of UE weak signal strength from the source gNB, wherein a first bunch would be UEs may have a weakest signal strength received from the satellite/gNB, e.g. those in most urgent need of completing the handover before loss of connection, wherein weakness is based on a threshold or as a threshold percentage of the group; wherein next groups are selected periodically, based on UEs with stronger signals (e.g. above another threshold or based on a second threshold percentage.

Bunching is performed based on load balancing: examining the data flows carried by UEs and the loads they impose on the network. UEs may be bunched such that total loads are even across bunches, and so that some bunches do not pose significantly (above a threshold) higher loads than others; wherein higher priority bunching is performed, e.g. assigning higher priority (e.g. earlier handovers) to UEs with QoS-critical data flows, e.g. low-latency flows, Guaranteed Bit Rate (GBR) flows, etc. wherein randomized groups of UEs are created to support the bunching.

Dividing of UEs into groups is performed based on any one or more of the parameters disclosed herein including lower layer (PHY) layer parameters.

Providing, by a UE, a capability indicator to an old gNB; wherein based on the capability indicator, the UE is grouped for handover in accordance with one or more of an: always on SSB or an on demand SSB of an old gNB or a new gNB.

In embodiments bunching may comprise generating, by a gNB or another network node, a plurality of network IDs; assigning a group of UEs to a network ID of the plurality of network IDs, wherein the plurality of network IDs are associated with an old or new gNB; handing over the group of UEs in accordance with the network ID and handing over another group of UEs in accordance with another network ID which is different from the network ID, wherein both the network ID and the another network ID are of the plurality of network IDs. Handover groups have a same or different orthogonal cover code, wherein the OCC is assigned to the UE, wherein the OCC is associated with a network ID.

We claim:

1. A method for satellite network mobility performed by a wireless device, the method comprising:
communicating, by the wireless device, data through a wireless network via a first connection to a first satellite;
predicting, by the wireless device, a loss of connection to the first satellite;
selecting, by the wireless device, a second satellite to move to, wherein the selecting is performed among candidate satellites on different visible orbital planes, wherein the second satellite employs a primary cell which carries an always on synchronization signal block (AO-SSB) and one or more secondary cells which carry an on demand synchronization signal block (OD-SSB);
requesting, by the wireless device, the network to enable establishment of a second connection from the device to the selected second satellite, in a multi-connection configuration including the first connection to the first satellite; and
establishing, by the wireless device, a second connection to the second satellite simultaneous with the first connection with the first satellite.

2. The method of claim 1, wherein, as part of the multi-connection, the data flows are moved from the first satellite to the second satellite, wherein some of the data flows moved to the second satellite are supported by the primary cell and some of the data flows are supported by the one or more secondary cells.

3. The method of claim 1, wherein, as part of the multi-connection, the data flows are split across paths through the first satellite and the second satellite.

4. The method of claim 1, further comprising:
providing, by the wireless device, an indication to the network of imminent loss of the service link to the first satellite;
releasing, by the wireless device, its connection to the first satellite and staying on the second satellite.

5. The method of claim 1, wherein a trigger for activation of the one or more secondary cells is carried on the primary cell, wherein the trigger defines a secondary cell timing activation window.

6. The method of claim 1, wherein one or more of the secondary cells are initially activated without an associated synchronization signal block (SSB) and it is assumed that the primary cell AO-SSB is sufficient for the scheduling of resources in the SCell.

7. The method of claim 1, wherein on a condition the wireless device is a secondary cell UE, the wireless device is subsequently scheduled for synchronization signal block (SSB) activation.

8. A method performed by a wireless device, the method comprising:
establishing a multi-connection with a first satellite and a second satellite;
wherein the first satellite has a primary cell and a secondary cell with same signaling numerology;
wherein the second satellite has a primary cell and a secondary cell with different signaling numerology;
wherein the secondary cell of the first satellite and the secondary cell of the second satellite have on-demand synchronization signal block (OD-SSB) configurations;
determining a time instance for enabling an OD-SSB of the secondary cell of the first satellite; and
determining a time instance for enabling an OD-SSB of the secondary cell of the second satellite and a subcarrier spacing to be used for timing configuration of the secondary cell of the second satellite.

9. The method of claim 8, wherein, for the first satellite, the primary cell and secondary cell subcarrier spacing (SCS) are the same, the wireless device assumes that the SCS is defined by the PCell activation whether it is semi-static via a MAC CE or a dynamic indication via the active BWP that the SCell belongs.

10. The method of claim 8, wherein the wireless device determines an SCS to use for the OD-SSB timing of the secondary cell of the secondary satellite, wherein in the case of a semi-static indication through a MAC CE and/or RRC, the wireless device assumes that the SCS that it receives via the activation from the active BWP with which it belongs is to be used.

11. The method of claim 10, wherein on a condition the wireless device receives an activation from a group-common active BWP that is different from the BWP to which it belongs it assumes the SCS it should use is the minimum of the two.

12. A bunching method comprising:
dividing a population of wireless devices into groups (bunches);
transmitting, by a satellite network node, one or more TRANSFER UE CONTEXTS messages including information on a group of wireless devices;
sending context information pertaining to a first set of wireless devices, to another satellite network node;
delaying a period of time, based on a delay; and
sending a next set of wireless devices' contexts information after the delay period;

13. The bunching method of claim 12, wherein bunching is performed in order of weakness of wireless device signal strength, wherein a first bunch includes wireless devices having a weakest signal strength;
wherein next groups are selected periodically, based on wireless devices with stronger signals.

14. The bunching method of claim 12, wherein bunching is performed based on load balancing including examining data flows carried by wireless devices and the loads imposed on the network;
wherein mobile devices are bunched such that total loads are even across bunches.

15. The bunching method of claim 12, wherein handover groups have a same or different orthogonal cover code (OCC) which is associated with a network ID.
